(19) United States
(12) Patent Application Publication
(10) Pub. No.: US 2017/0155522 A1
(43) Pub. Date: Jun. 1, 2017

(54) COMMUNICATION APPARATUS AND COMMUNICATION SYSTEM

(71) Applicant: FUJITSU LIMITED, Kawasaki-shi (JP)

(72) Inventors: Hiroshi Fukaya, Chikusei (JP); YUTAKA HAYAMA, Sano (JP); NOBUYUKI FUKUCHI, Oyama (JP); HIROYUKI SUZUKI, Utsunomiya (JP); SHIGEO HANDA, Moka (JP); Koji Suda, Tochigi (JP); TAKANOBU WAKABAYASHI, Utsunomiya (JP); TOSHIYUKI SAKAMOTO, Yuki (JP)

(73) Assignee: FUJITSU LIMITED, Kawasaki-shi (JP)

(21) Appl. No.: 15/348,221

(22) Filed: Nov. 10, 2016

(30) Foreign Application Priority Data
Nov. 26, 2015 (JP) 2015-230895

(51) Int. Cl. H04L 12/18; H04L 12/26; H04L 12/24; H04L 12/437

(52) U.S. Cl. CPC H04L 12/1868; H04L 12/437; H04L 12/1886; H04L 43/0835; H04L 41/0816

(57) ABSTRACT

There is provided a communication apparatus of a plurality of communication apparatuses forming a ring network, the communication apparatus includes: a transmitter configured to transmit a multicast packet to a first communication apparatus of the plurality of communication apparatuses; a receiver configured to receive data of a reception failure of the multicast packet from the first communication apparatus; and a transmission controller configured to stop transmitting of the multicast packet from the transmitter according to the data of the reception failure.

### CR0SS-REFERENCE TO RELATED APPLICATION

This application is based upon and claims the benefit of priority of the prior Japanese Patent Application No. 2015-230895, filed on Nov. 26, 2015, the entire contents of which are incorporated herein by reference.

### FIELD

The embodiments discussed herein are related to a communication apparatus and a communication system.

### BACKGROUND

A network including a plurality of nodes connected in the form of a ring is known (see, e.g., Japanese Laid-Open Patent Publication No. 2006-270169). A ring network has an advantage of, for example, redundancy of traffic routes.

With regard to the ring network, for example, an Ethernet® ring protection (ERP) is defined in the ITU-T (International Telecommunication Union-Telecommunication Standardization Sector) Recommendation G.8032.

According to the Ethernet® ring protection, a loop of packets in the ring network is prevented by blocking a port of a ring protection link (RPL) connecting a master mode and an adjacent node thereof among a plurality of nodes connected in the form of a ring. In addition, when a failure occurs in other link, a traffic route may be re-established by blocking a port of the link, and simultaneously transmitting a ring-automatic protection switching (R-APS) (or a signal fail (SF)) to the ring network and releasing the port blocking of the ring protection link.

A process, which is called a “filtering data base (FDB) flash,” is used for the re-establishment of the traffic route. Each node clears a media access control (MAC) address table by performing the FDB flash. For this reason, each node re-learns the MAC addresses by flooding packets and updates the MAC address table.

Accordingly, in the event of a link failure, the traffic route is switched. In addition, time taken for the switching of the traffic route by the Ethernet ring protection is shorter than time taken for switching of a route by a spanning tree protocol.

Related technologies are disclosed in, for example, Japanese Laid-Open Patent Publication No. 2006-270169.

### SUMMARY

According to an aspect of the invention, a communication apparatus of a plurality of communication apparatuses forming a ring network, the communication apparatus includes: a transmitter configured to transmit a multicast packet to a first communication apparatus of the plurality of communication apparatuses; a receiver configured to receive data of a reception failure of the multicast packet from the first communication apparatus; and a transmission controller configured to stop transmitting of the multicast packet from the transmitter according to the data of the reception failure.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a route of a unicast packet in a comparative example;

FIG. 2 is a view illustrating a route of a unicast packet in the event of a failure in the comparative example;

FIG. 3 is a view illustrating a route of a unicast packet in the event of FDB flash in the comparative example;

FIG. 4 is a view illustrating a route of a unicast packet after route switching in the comparative example;

FIG. 5 is a view illustrating a route of a multicast packet in the comparative example;

FIG. 6 is a view illustrating a route of a multicast packet in the event of a failure in the comparative example;

FIG. 7 is a view illustrating a route of a multicast packet in a first embodiment;

FIG. 8 is a view illustrating a route of a multicast packet in the event of a failure in the first embodiment;

FIG. 9 is a view illustrating the operation of a communication system according to the first embodiment;

FIG. 10 is a view illustrating the configuration of a communication apparatus according to the first embodiment;

FIG. 11 is a view illustrating the operation of a communication system according to a second embodiment;

FIG. 12 is a view illustrating the operation of a communication apparatus according to the second embodiment;

FIG. 13 is a view illustrating an MAC address table before and after being changed;

FIG. 14 is a flow chart illustrating the operation of a communication apparatus according to the second embodiment;

FIG. 15 is a view illustrating the operation of a communication apparatus according to a third embodiment;

FIG. 16 is a view illustrating one configuration example of a continuity check message (CCM) packet;

FIG. 17 is a view illustrating a route of a multicast packet in a fourth embodiment;

FIG. 18 is a view illustrating a route of a multicast packet in the event of a failure in the fourth embodiment;

FIG. 19 is a view illustrating the operation of a communication system according to the fourth embodiment;

FIG. 20 is a view illustrating the operation of a communication apparatus according to the fourth embodiment;

FIG. 21 is a flow chart illustrating the operation of an interface card according to the fourth embodiment; and

FIG. 22 is a flow chart illustrating the operation of a control card according to the fourth embodiment.

### DESCRIPTION OF EMBODIMENTS

With the spread of video delivery services and the like, the amount of traffic of a multicast packet with plural destinations is increasing in a ring network. For a unicast packet having a single destination, a traffic route is determined as a single route. However, for a multicast packet, a traffic route is divided and is not determined as a single route since the multicast packet is always flooded in each node.

Therefore, the multicast packet is transmitted from not only a port connected a link having no failure but also a port connected to a link having a failure. For example, in a case where a failure monitoring section is present between two ports communicating along separate communication routes in each communication direction, when a failure occurs in only a communication route in one communication direction, only a receiving side port may be blocked while a transmitting side port may not be blocked.

In this case, the multicast packets are continuously transmitted from the transmitting side port to the receiving side port, and discarded in the receiving side port. Accordingly, a wasteful band occupied by a discarded traffic may occur in a node in the course of a communication route where a failure occurred.

Hereinafter, embodiments of a technique for preventing the band occupancy by the traffic to be discarded when a failure occurs will be described with reference to the accompanying drawings.

### COMPARATIVE EXAMPLE

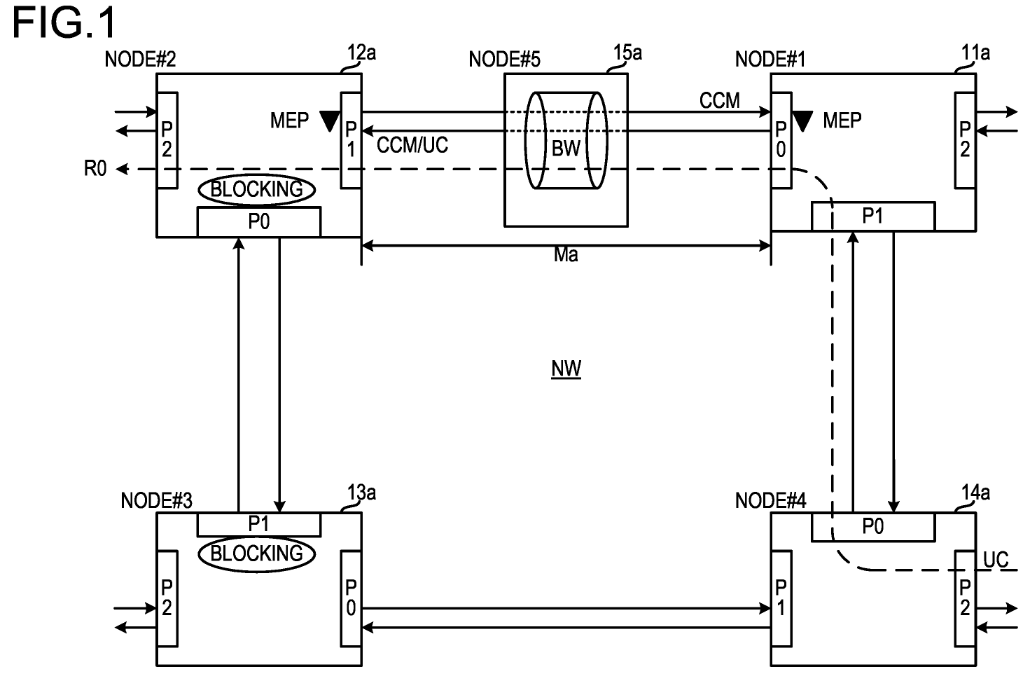

FIG. 1 illustrates a route R0 of a unicast packet UC in a comparative example. A ring network NW includes nodes #1 to #5 connected in a ring shape. The nodes #1 to #5 are provided with their respective communication apparatuses 11a to 15a. Examples of the nodes #1 to #5 may include, but are not limited to, the layer 2 switches. The ring network NW is an example of a communication system.

As an example, each of the communication apparatuses 11a to 14a includes the Ethernet ring protection function defined in the ITU-T Recommendation G.8032. Therefore, the communication apparatuses 11a to 14a perform a traffic route switching when a failure occurs in a link or the like among the communication apparatuses 11a to 14a. In this example, a traffic route switching will be described below in a case where a failure occurs in a link between the communication apparatus 11a and the communication apparatus 12a.

Each of the communication apparatuses 11a to 14a has ports P0 to P2 for the routes thereof, respectively. Each of the ports P0 to P2 is a packet transceiver, and each communication apparatus 11a to 14a transmits a packet, which is input from one of the ports P0 to P2, to the other ports P0 to P2. An example of the packet may include, but is not limited to, an Ethernet frame.

Between one set of opposing communication apparatuses 11a to 14a, the ports P0 and P1 form a link of an Ethernet ring. That is, the ports P0 and P1 are connected to the inside of the ring network NW. A port P2 of each communication apparatus 11a to 14a is connected to the outside of the ring network NW. Transmission lines are separately provided for a transmitting direction and a receiving direction of each communication apparatus 11a to 14a.

In the ring network NW, a link between a node #2 and a node #3 is set to RPL. Therefore, the port P0 of the communication apparatus 12a and the port P1 of the communication apparatus 13a are blocked (see “BLOCKING”), and a packet transmitted to the port P0 of the communication apparatus 12a and the port P1 of the communication apparatus 13a are discarded.

In addition, a monitoring section Ma is set between the port P0 of the communication apparatus 11a and the port P1 of the communication apparatus 12a , and a maintenance end point (MEP) as a termination of operation, administration, and maintenance (OAM) is set in the near ends of the port P0 of the communication apparatus 11a and the port P1 of the communication apparatus 12a (see “▾”). The MEP is defined in ITU-T Recommendation Y.1731.

A CCM packet is being transmitted/received between MEPs of the communication apparatuses 11a and 12a . Each communication apparatus 11a and 12a monitors the state of a communication route between the communication apparatuses 11a and 12a by the transmission/reception of the CCM packet.

In addition, a communication apparatus 15a of a node #5 is provided in a transmission line between the communication apparatuses 11a and 12a . Therefore, the CCM packet is transmitted/received through the communication apparatus 15a.

As an example, a route R0 of a unicast packet UC is set in the ring network NW. The route R0 goes through the communication apparatus 14a , the communication apparatus 11a , the communication apparatus 15a , and the communication apparatus 12a in this order, as indicated by a dashed line.

Accordingly, the communication apparatus 11a transmits the unicast packet UC, which is input from the port P1, to the port P0 and transmits it to the communication apparatus 12a of the node #2. Therefore, the unicast packet UC and the CCM packet are transmitted using a band BW of the communication apparatus 15a of the node #5 between the communication apparatus 11a and the communication apparatus 12a.

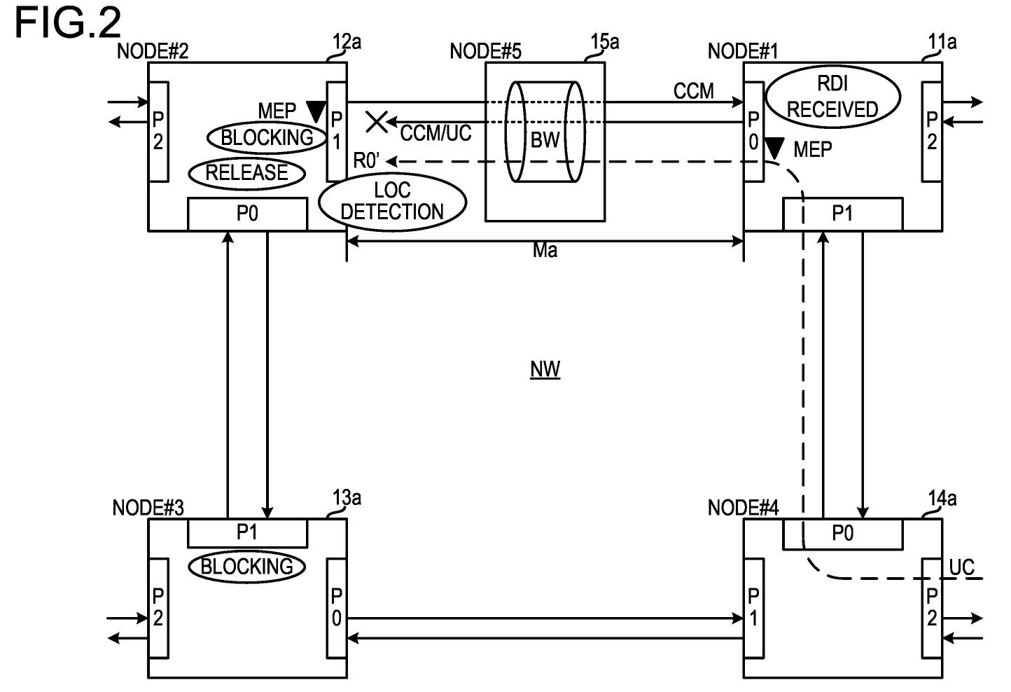

FIG. 2 illustrates a route R0' of a unicast packet UC in the event of a failure in the comparative example. In FIG. 2, the same elements as those in FIG. 1 will be denoted by the same reference numerals as used in FIG. 1, and explanation thereof will be omitted.

Of two-way transmission lines connecting between the communication apparatus 11a and the communication apparatus 12a , when a failure occurs on a transmission line directing from the communication apparatus 11a to the communication apparatus 12a , the communication apparatus 12a is unable to receive the CCM packet and the unicast packet UC (see “×”). The MEP of the communication apparatus 12a detects a loss of continuity (LOC) as a failure because the CCM packet is not received (see “LOC detection”). The LOC is an example of a reception failure of a multicast packet MC.

The communication apparatus 12a releases the blocking of the port P0 by the detection of LOC (see “RELEASE”) and reports the occurrence of LOC to the communication apparatus 13a of the node #3. The communication apparatus 13a releases the blocking of the port P1 according to the LOC report (see “RELEASE”). Then, the communication apparatus 12a blocks the port P1 in which the LOC is detected (see “BLOCKING”).

In addition, the communication apparatus 12a reports the occurrence of LOC to the communication apparatus 11a by remote defect indication (RDI) included in the CCM packet. At this time, a transmission line directing from the communication apparatus 12a to the communication apparatus 11a is assumed as normal. Although the communication apparatus 11a detects the occurrence of LOC in the communication apparatus 12a by receiving RDI (see “RDI RECEIVED”), the port P0 of the communication apparatus 11a is not blocked since the LOC is a failure of the different communication apparatus 12a . In addition, the communication apparatus 14a of the node #4 is also reported with R-APS (SF) from the communication apparatus 12a to know that the LOC occurs in the communication apparatus 12a . CCM including RDI is an example of the LOC report.

Upon detecting the occurrence of LOC by means of RDI or R-APS (SF), each of the communication apparatuses 11a to 14a of the nodes #1 to #4 clears an MAC address table by performing the FDB flash.

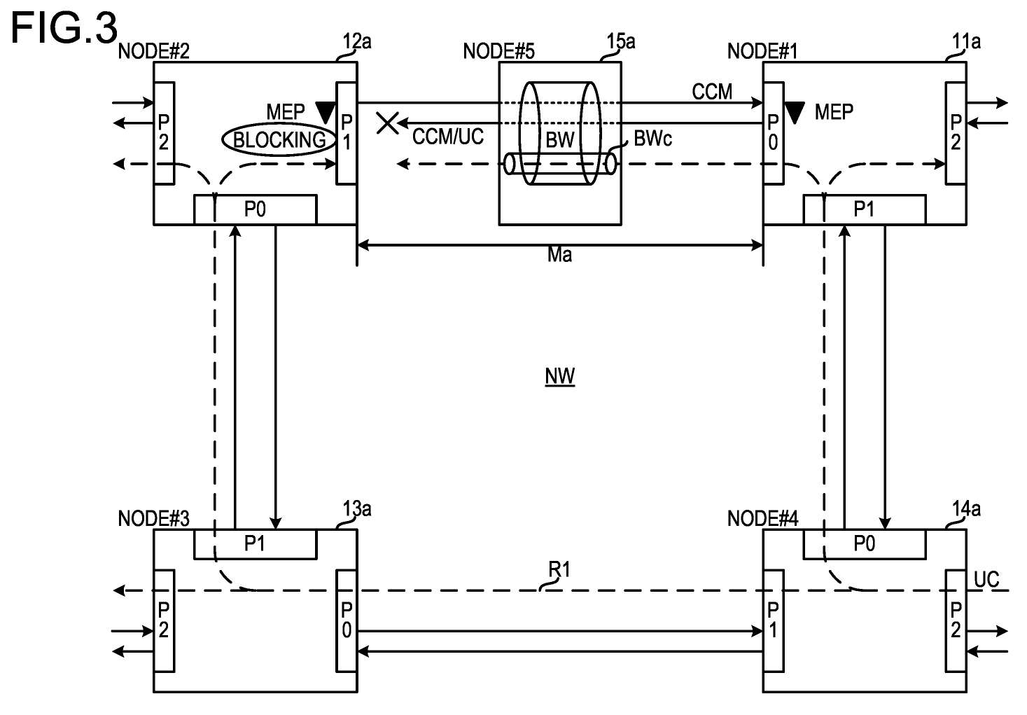

FIG. 3 illustrates a route R1 of a unicast packet UC in the event of FDB flash in the comparative example. In FIG. 3, the same elements as those in FIG. 1 will be denoted by the same reference numerals as used in FIG. 1, and explanation thereof will be omitted.

The communication apparatuses 11a to 14a flood the unicast packet UC because of the FDB flash. Therefore, the route R0′ of the unicast packet UC is divided in each node #1 to #4.

For example, the communication apparatus 14a transmits the unicast packet UC, which is input from the port P2, to the ports P0 and P1. The communication apparatus 11a transmits the unicast packet UC, which is input from the port P1, to the ports P0 and P2.

Therefore, a portion BWc of the band BW of the communication apparatus 15a of the node #5 is used for the transmission of the unicast packet UC. However, since the unicast packet UC transmitted from the communication apparatus 15a is discarded, the communication apparatus 12a is unable to receive the unicast packet UC.

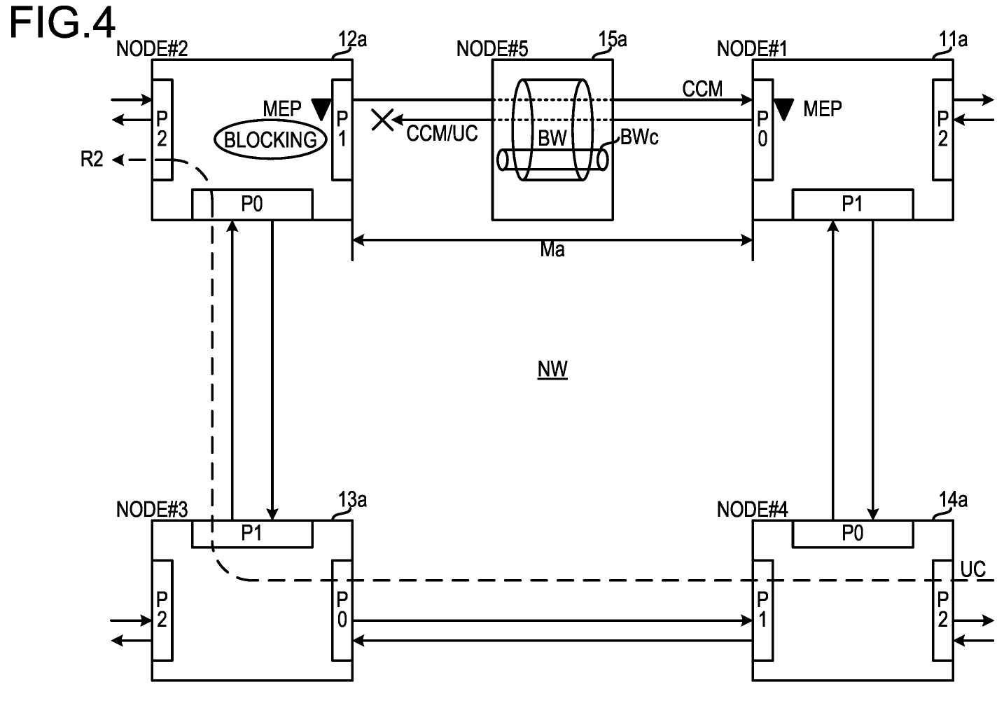

FIG. 4 illustrates a route R2 of a unicast packet UC after route switching in the comparative example. In FIG. 4, the same elements as those in FIG. 1 will be denoted by the same reference numerals as used in FIG. 1, and explanation thereof will be omitted.

Each of the communication apparatuses 11a to 14a of the nodes #1 to #4 relearns an MAC address by flooding of the unicast packet UC and updates an MAC address table. Accordingly, a route R2 of the unicast packet UC is reestablished in the ring network NW. Accordingly, the unicast packet UC is switched from the route R1 to the route R2.

The route R2 after the switching goes through the communication apparatus 14a , the communication apparatus 13a and the communication apparatus 12a in this order, as indicated by a dashed line. Therefore, the unicast packet UC does not go through the communication apparatus 15a of the node #5, and the band BWc used for the unicast packet UC before the switching is released.

In this way, although a traffic route is determined as a single rout for a unicast packet UC having one destination, divided traffic routes come to exist and a traffic route is not determined as a single route for a multicast packet since the multicast packet is always flooded in each node #1 to #4.

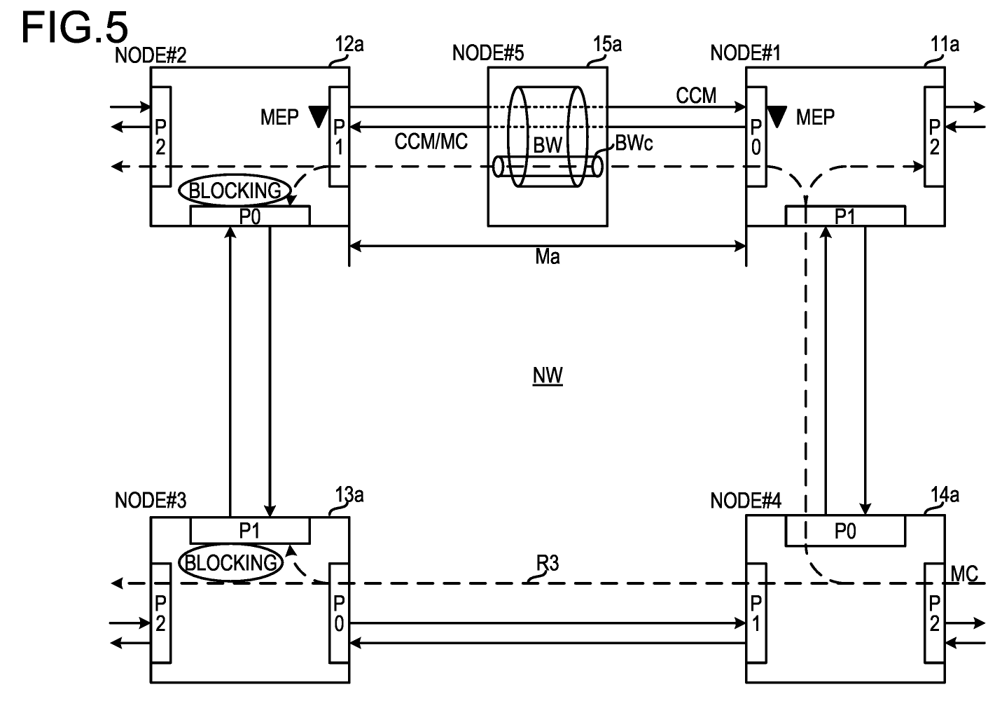

FIG. 5 illustrates a route R3 of a multicast packet MC in the comparative example. In FIG. 5, the same elements as those in FIG. 1 will be denoted by the same reference numerals as used in FIG. 1, and explanation thereof will be omitted.

A route R3 of the multicast packet MC is divided in each of the communication apparatuses 11a to 14a of the nodes #1 to #4, as indicated by a dashed line. However, the multicast packet MC cannot pass between the communication apparatuses 12a and 13a due to the blocking of the ports P0 and P1 of the communication apparatuses 12a and 13a.

The communication apparatus 14a replicates the multicast packet MC input from the port P2 and transmits the replicated multicast packet MC to the ports P0 and P1. The port P0 transmits the multicast packet MC to the communication apparatus 11a , and the port P1 transmits the multicast packet MC to the communication apparatus 13a.

The communication apparatus 11a replicates the multicast packet MC input from the port P1 and transmits the replicated multicast packet MC to the ports P0 and P2. The port P0 transmits the multicast packet MC to the communication apparatus 12a via the communication apparatus 15a of the node #5. Therefore, a portion BWc of the band BW of the communication apparatus 15a of the node #5 is used for transmission of the multicast packet MC.

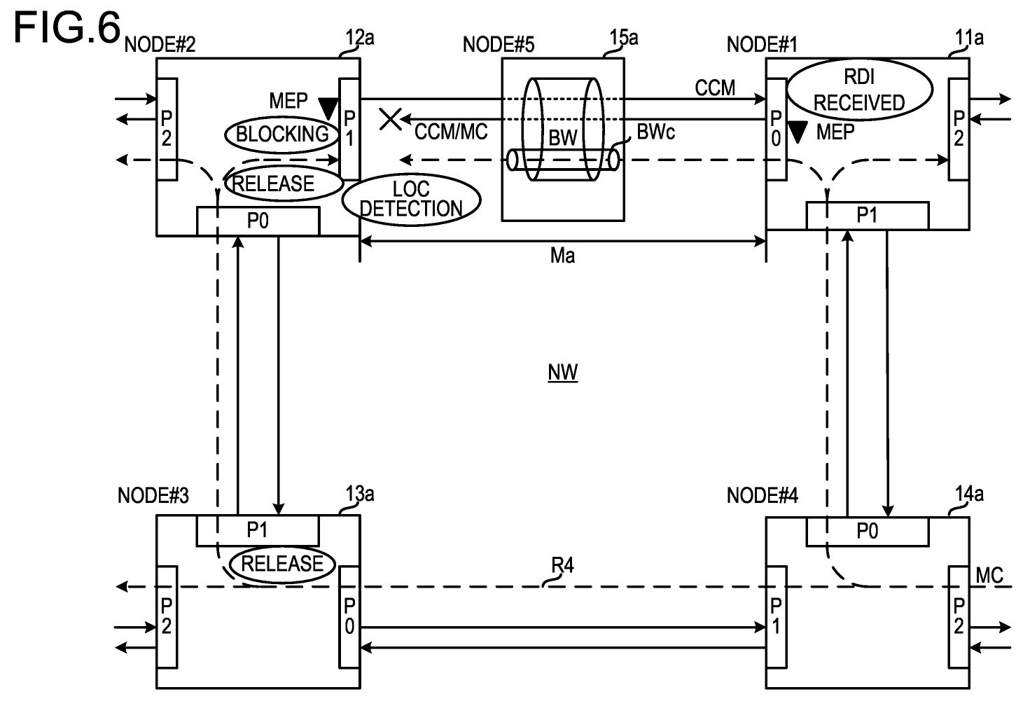

FIG. 6 illustrates a route R4 of a multicast packet MC in the event of a failure in the comparative example. In FIG. 6, the same elements as those in FIG. 1 will be denoted by the same reference numerals as used in FIG. 1, and explanation thereof will be omitted. In this example, as described with reference to FIG. 2, since the CCM packet is not received from the communication apparatus 11a , the communication apparatus 12a detects the LOC and reports the occurrence of LOC to the communication apparatus 11a by RDI

The communication apparatus 12a releases the blocking of the port P0 by the detection of LOC (see “RELEASE”) and reports the occurrence of LOC to the communication apparatus 13a of the node #3. The communication apparatus 13a releases the blocking of the port P1 according to the LOC report (see “RELEASE”). Then, the communication apparatus 12a blocks the port P1 in which the LOC is detected (see “Blocking”).

Therefore, the multicast packet MC input from the port P0 of the communication apparatus 13a is replicated and transmitted to the ports P1 and P2, and the multicast packet MC transmitted from the port P1 of the communication apparatus 13a is input to the port P0 of the communication apparatus 12a . Although the communication apparatus 12a replicates the multicast packet MC input from the port P0 and transmits the replicated packets to the ports P1 and P2, since the port P1 is blocked, the multicast packet MC transmitted to the port P1 is discarded.

In addition, the communication apparatus 11a replicates the multicast packet MC input from the port P1 and transmits the replicated packets to the ports P0 and P2. Since the port P0 is not blocked even when the LOC is detected by RDI as described above, the port P0 transmits the multicast packet MC to the communication apparatus 12a via the communication apparatus 15a of the node #5.

Unlike the unicast packet UC, the multicast packet MC continues to be flooded even after the MAC address is updated by FDB flash. Therefore, the port P0 of the communication apparatus 11a continues to transmit the multicast packet MC to the communication apparatus 12a . However, since the unicast packet UC transmitted from the communication apparatus 15a is discarded, the communication apparatus 12a is unable to receive the unicast packet UC.

Accordingly, the band BWc of the communication apparatus 15a in the route of transmission continues to be used for the discarded multicast packet MC. Therefore, in the node #5, the band BWc is wastefully occupied by traffic of the discarded multicast packet MC.

### First Embodiment

Thus, in some embodiments, in a ring network NW, when each communication apparatus receives RDI from another communication apparatus, by stopping transmission of a multicast packet MC to the corresponding communication apparatus, a band BWc is prevented from being occupied by discarded traffic.

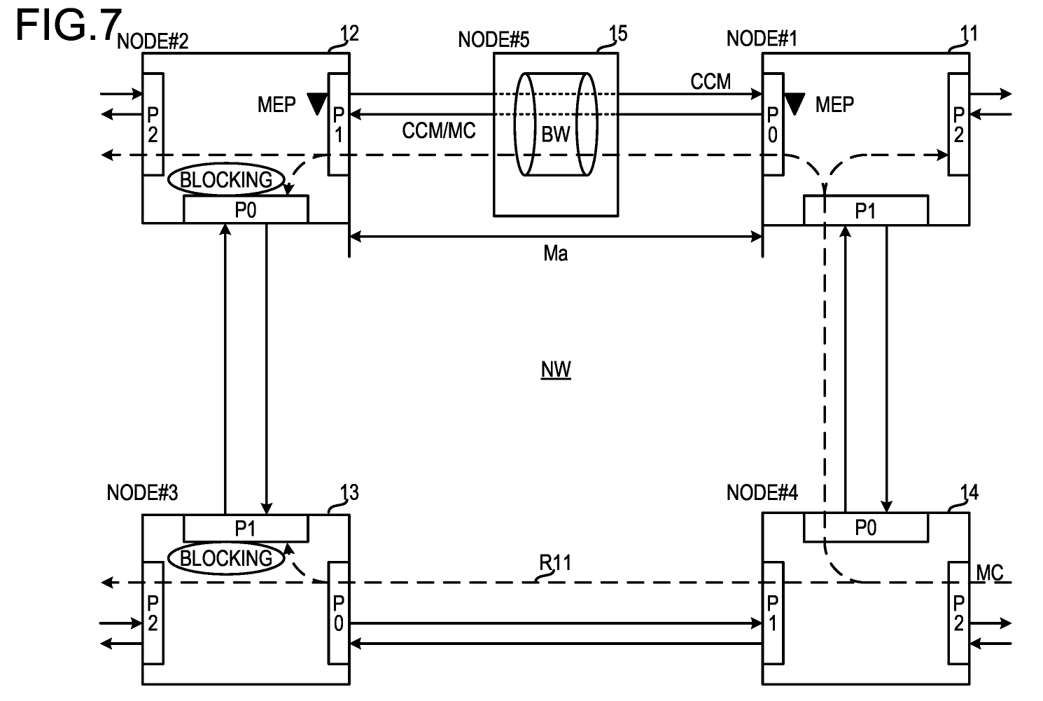

FIG. 7 illustrates a route R11 of a multicast packet MC in a first embodiment. In this embodiment, a ring network NW includes nodes #1 to #5 connected in a ring shape, as in the comparative example. The nodes #1 to #5 are respectively provided with communication apparatuses 11 to 15 corresponding to the communication apparatuses 11a to 15a of the comparative example.

In the same way as the comparative example, the port P0 of the communication apparatus 12 and the port P1 of the communication apparatus 13 are blocked. In addition, a monitoring section Ma by MEP is set between the communication apparatus 11 and the communication apparatus 12.

The route R11 of the multicast packet MC is divided in each of the communication apparatuses 11 to 14 of the nodes #1 to #4. However, the multicast packet MC cannot pass through the communication apparatus 12 and the communication apparatus 13 since the ports P0 and P1 of the communication apparatuses 12 and 13 are blocked.

The communication apparatus 11 replicates the multicast packet MC input from the port P1 and transmits the replicated packets to the ports P0 and P2. The port P0 transmits the multicast packet MC to the communication apparatus 12 via the communication apparatus 15 of the node #5. Therefore, a portion BWc of the band BW of the communication apparatus 15 of the node #5 is used for the transmission of the multicast packet MC.

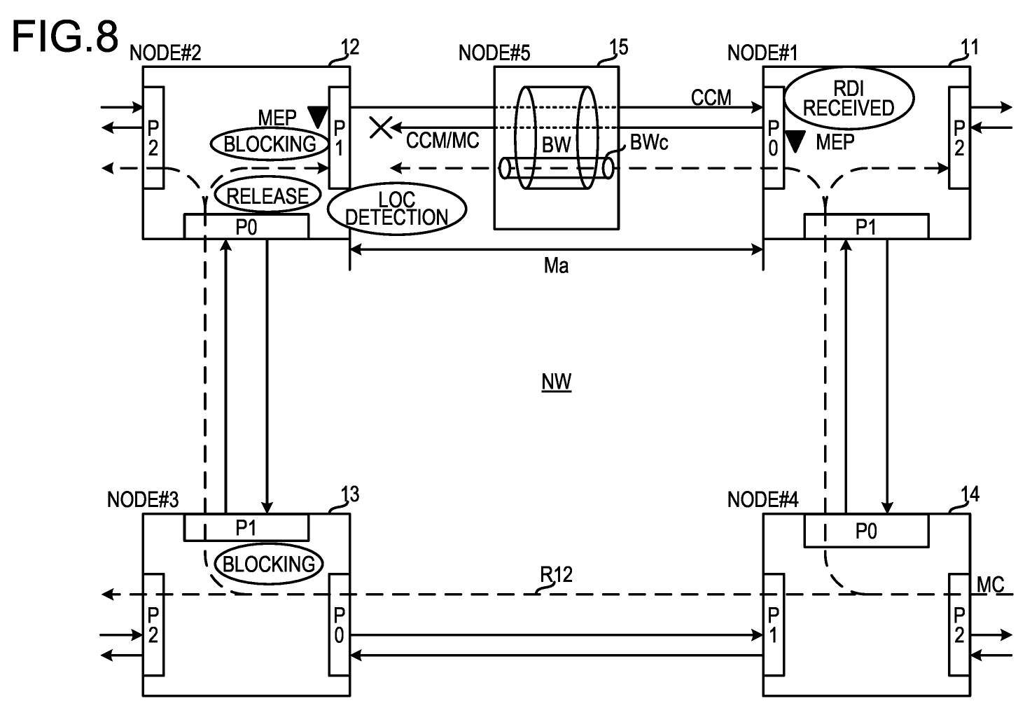

FIG. 8 illustrates a route R12 of a multicast packet MC in the event of a failure in the first embodiment. In FIG. 8, the same elements as those in FIG. 7 will be denoted by the same reference numerals as used in FIG. 7, and explanation thereof will be omitted.

In this example, similar to the example of FIG. 6, since a CCM packet is not received from the communication apparatus 11, the communication apparatus 12 detects the LOC and reports the occurrence of LOC to the communication apparatus 11 by RDI. The communication apparatus 12 releases the blocking of the port P0 by the detection of LOC (see “RELEASE”) and reports the occurrence of LOC to the communication apparatus 13 of the node #3. The communication apparatus 13 releases the blocking of the port P1 according to the LOC report (see “RELEASE”). Then, the communication apparatus 12 blocks the port P1 in which the LOC is detected (see “BLOCKING”).

In addition, the communication apparatus 11 replicates the multicast packet MC input from the port P1 and transmits the packet to the ports P0 and P2. Since the port P0 is not blocked even when the LOC is detected by RDI as described above, the port P0 transmits the multicast packet MC to the communication apparatus 12 via the communication apparatus 15 of the node #5. Therefore, the communication apparatus 11 performs a control to stop the transmission of the multicast packet MC from the port P0, as described below.

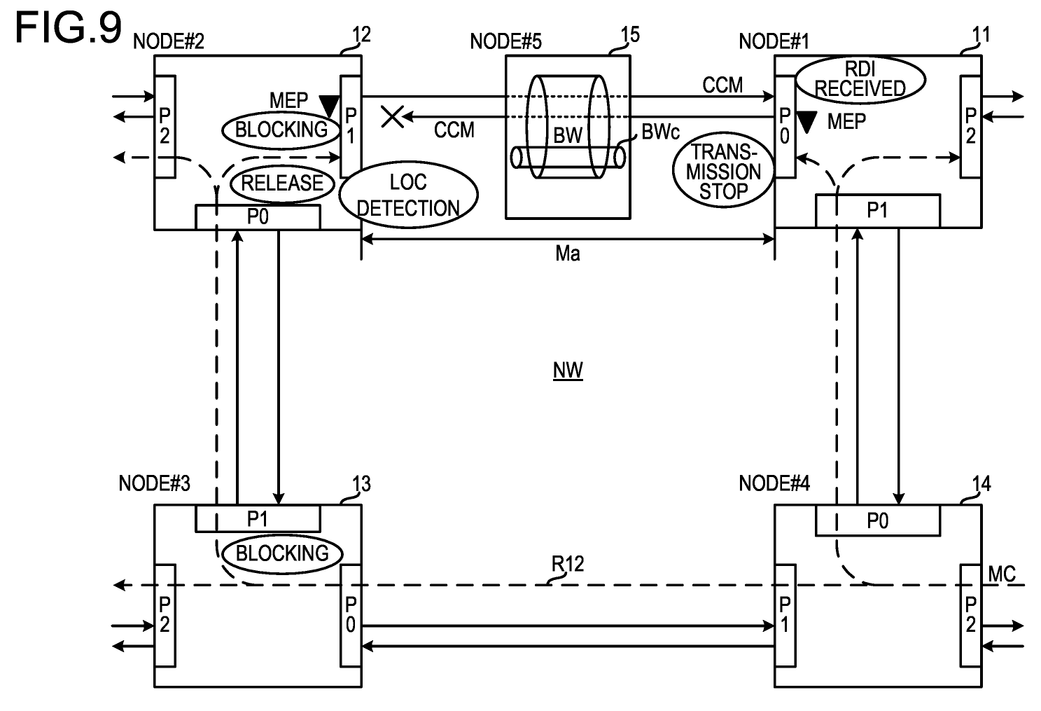

FIG. 9 illustrates the operation of a communication system according to the first embodiment. In FIG. 9, the same elements as those in FIG. 7 will be denoted by the same reference numerals as used in FIG. 7, and explanation thereof will be omitted.

The communication apparatus 12, which is an example of a fourth communication apparatus, detects LOC (see “LOC DETECTION”) and reports it to the communication apparatus 11 by RDI. The communication apparatus 11, which is an example of a third communication apparatus, stops the transmission of the multicast packet MC from the port P0 (see “TRANSMISSION STOP”) in response to receiving RDI (see “RDI RECEIVED”).

Therefore, in the communication apparatus 15 of the node #5, the band BWc occupied by the discarded multicast packet MC is released. Accordingly, the band BWc is prevented from being occupied by traffic discarded when the LOC occurs. Accordingly, the communication apparatus 15 can use the released band BWc for other traffic.

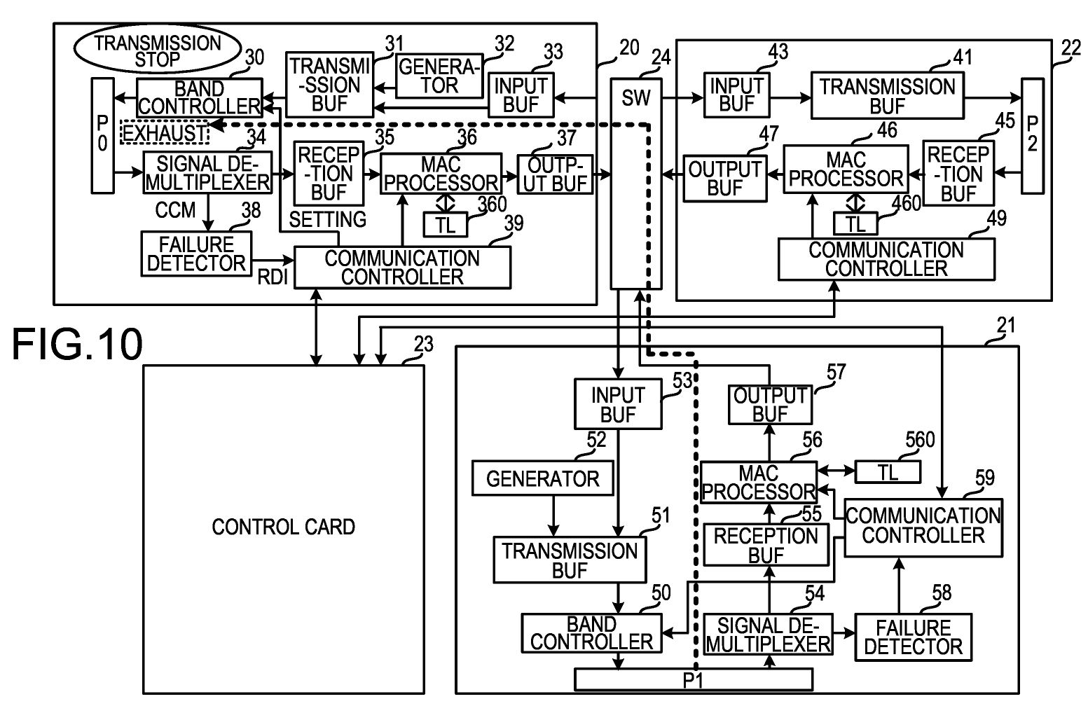

FIG. 10 is a view illustrating the configuration of the communication apparatus 11 according to the first embodiment. Although the communication apparatus 11 of the node #1 is described as an example in this embodiment, other communication apparatuses 12 to 14 of the nodes #2 to #4 also have the same configuration as that of the communication apparatus 11.

The communication apparatus 11 includes interface cards (hereinafter, referred to as “IF cards”) 20 to 22 for the respective ports P0 to P2, a switch card (hereinafter, referred to as a “SW card”) 24, and a control card 23. The IF cards 20 to 22, the SW card 24, and the control card 23 are, for example, electronic circuit boards on which a variety of electronic parts are mounted, and are respectively inserted in slots installed in the front of a housing the communication apparatus 11. The IF cards 20 to 22, the SW card 24, and the control card 23 transmit/receive signals, for example, through a printed circuit board installed in the rear of the housing of the communication apparatus 11.

The IF card 20 includes a port P0, a band controller 30, a transmission buffer (BUF) 31, a generator 32, an input buffer (BUF) 33, a signal de-multiplexer (De-MUX) 34, a reception buffer (BUF) 35, an MAC processor 36, and an MAC address table (TL) 360. The IF card 20 further includes an output buffer (BUF) 37, a failure detector 38, and a communication controller 39.

The IF card 21 includes a port P1, a band controller 50, a transmission buffer 51, a generator 52, an input buffer 53, a signal de-multiplexer 54, a reception buffer 55, an MAC processor 56, and an MAC address table 560. The IF card 21 further includes an output buffer 57, a failure detector 58, and a communication controller 59.

The IF card 22 includes a port P2, a transmission buffer 41, an input buffer 43, a reception buffer 45, an MAC processor 46, an MAC address table 460, an output buffer 47, and a communication controller 49. The SW card 24 exchanges packets with the IF cards 20 to 22. More specifically, the SW card 24 transmits packets among the IF cards 20 to 22 according to reception destination information added to packets input from the IF cards 20 to 22.

The control card 23 is mounted thereon with a control processing unit (CPU) or the like and is operated by software. The control card 23 controls the IF cards 20 to 22 and the SW card 24.

First, the IF card 22 will be described. The input buffer 43 is, for example, a memory and stores a packet input from the SW card 24. The transmission buffer 41 is, for example, a memory and stores a packet read from the input buffer 43. The packet stored in the transmission buffer 41 is output from the port P2 to the outside of the ring network NW.

The reception buffer 45 is, for example, a memory and stores a packet input from the port P2. The MAC processor 46 reads a packet out of the reception buffer 45 and adds reception destination information (e.g., a tag) to the read packet based on the MAC address table 460. For a unicast packet UC, the MAC address table 460 is built by MAC address learning by flooding and registers destination address (DA), which is a reception destination of the unicast packet UC, and the ports P0 to P2 of an output destination, in association for each VID.

For a multicast packet MC, the MAC address table 460 registers DA of the multicast packet MC and the ports P0 to P2 of a transmission destination replicating and transmitting the multicast packet MC, in association.

The output buffer 47 is, for example, a memory and stores a packet output from the MAC processor 46. The SW card 24 reads a packet out of the output buffer 47 and outputs the read packet to the input buffers 33, 43 and 53 of the IF cards 20 to 22 according to reception destination information added to the packet.

The communication controller 49 performs setting and control of the IF card 22. For example, the communication controller 49 instructs the MAC processor 46 to change the MAC address table 460.

Next, the IF cards 20 and 21 will be described. Each of the input buffers 33 and 53 is, for example, a memory and stores a packet input from the SW card 24. The generators 32 and 52 generate a CCM packet in a certain cycle and output it to the transmission buffers 31 and 52, respectively. The transmission buffers 31 and 52 are, for example, memories and store CCM packets generated by the generators 32 and 52 and packets read out of the input buffers 33 and 53, respectively. The packets read out of the input buffers 33 and 53 refer to the above-mentioned unicast packet UC and multicast packet MC rather than the CCM packets.

The band controllers 30 and 50 control bands of the packets transmitted from the ports P0 and P1 based on band values set from the communication controllers 39 and 59, respectively. More specifically, the band controllers 30 and 50 read packets and CCM packets out of the transmission buffers 31 and 51 for each virtual local area network (LAN) identifier (VID) for identifying packets, respectively, and output them to the ports P0 and P1, respectively. Each of the band controllers 30 and 50 is an example of a transmitter for transmitting the multicast packet MC to the communication apparatus 12, and the VID is an example of identification information of the multicast packet MC.

The signal de-multiplexers 34 and 54 separate the CCM packets input from the ports P0 and P1 from typical packets, respectively, and output them to the failure detectors 38 and 58, respectively. In addition, the signal de-multiplexers 34 and 54 output the typical packets to the reception buffers 35 and 55, respectively. The reception buffer 35 and 55 are, for example, memories and store packets input from the ports P0 and P1, respectively.

The MAC processors 36 and 56 read packets out of the reception buffers 35 and 55, respectively, and add reception destination information (e.g., a tag) to the read packets based on the MAC address tables 360 and 560, respectively. For the unicast packet UC, each of the MAC address tables 360 and 560 is built by MAC address learning by flooding and registers DA, which is a reception destination of the unicast packet UC, and the ports P0 to P2 of an output destination, in association for each VID.

For the multicast packet MC, each of the MAC address tables 360 and 560 registers DA of the multicast packet MC and the ports P0 to P2 of a transmission destination replicating and transmitting the multicast packet MC, in association. The MAC address table 560 is an example of transmission information indicating a transmission destination of the multicast packet MC. The MAC processors are an example of transmission processors which receive the multicast packet MC from the inside or outside of the ring network NW and transmit it to the band controllers 30 and 50 according to the MAC address tables 560 and 360, respectively.

The output buffers 37 and 57 are, for example, memories and store packets output from the MAC processors 36 and 56, respectively. The SW card 24 reads packets out of the output buffer 37 and 57 and outputs the read packets to the input buffers 33, 43 and 53 of the IF cards 20 to 22 according to the reception destination information added to the packets.

Each of the failure detectors 38 and 58 detects the occurrence of LOC in the other nodes #2 and #4 by receiving RDI in the CCM packet. Upon receiving the RDI, the failure detectors 38 and 58 report the RDI to the communication controllers 39 and 59, respectively. Each of the failure detectors 38 and 58 is an example of a receiver which receive RDI from other communication apparatuses 12 and 14.

The communication controllers 39 and 59 perform setting and control of the IF cards 20 and 21, respectively. For example, the communication controllers 39 and 59 instruct the MAC processors 36 and 56 to change the MAC address tables 360 and 460, respectively.

In addition, the communication controllers 39 and 59 set the band values for the band controllers 30 and 50 for each VID, respectively. In the example of FIG. 9, upon receiving RDI from the failure detector 38, the communication controller 39 instructs the band controller 30 to set a band value of the multicast packet MC of the corresponding VID to 0. Accordingly, since the multicast packet MC is discarded in the band controller 30 after being input from the IF card 21 to the IF card 20 through the SW card 24, as indicated by a dashed line, the multicast packet MC is not transmitted from the port P0. The CCM packet is transmitted from the port P0.

In this way, the communication controller 39 performs the stop control of the transmission of the multicast packet MC from the band controller 30 according to the RDI (see “TRANSMISSION STOP”). Therefore, as described above, in the communication apparatus 15 of the node #5, the band BWc occupied by the discarded multicast packet MC is released. In addition, the communication controller 59 also may perform the same process as the communication controller 39. Each of the communication controllers 39 and 59 is an example of a transmission controller.

The failure detectors 38 and 58 acquire the VID of the multicast packet MC from the CCM and report the VID to the communication controllers 39 and 59, respectively. The communication controller 39 instructs the band controllers 30 and 50 to set a band value of the VID reported from the failure detectors 38 and 58 to 0, respectively.

In this way, the communication controllers 39 and 59 acquire the VID of the multicast packet MC from the CCM and identify a multicast packet MC to be stopped, based on the VID. For this reason, the communication controllers 39 and 59 can easily perform the stop control of transmission of the multicast packet MC.

As described above, the communication apparatus 11 according to this embodiment is installed in the ring network NW and includes the band controller 30, the failure detector 38, and the communication controller 39. The band controller 30 transmits the multicast packet MC to other communication apparatus 12 installed in the ring network NW.

The failure detector 38 receives RDI from the communication apparatus 12. The communication controller 39 performs the stop control of transmission of the multicast packet MC from the band controller 30 according to the RDI.

With the above-described configuration, the communication controller 39 performs the stop control of transmission of the multicast packet MC from the band controller 30 according to the RDI. Therefore, in the communication apparatus 15 of the node #5, the band BWc occupied by the discarded multicast packet MC is released. Accordingly, the band BWc is prevented from being occupied by traffic discarded when the LOC occurs.

In addition, the communication system according to this embodiment includes the communication apparatus 11 and the communication apparatus 12 installed in the ring network NW. The communication apparatus 11 is installed in the ring network NW and includes the band controller 30, the failure detector 38, and the communication controller 39.

The band controller 30 transmits the multicast packet MC to the communication apparatus 12. The failure detector 38 receives the RDI from the communication apparatus 12. The communication controller 39 performs the stop control of transmission of the multicast packet MC from the band controller 30 according to the RDI. The communication apparatus 12 detects the LOC as a failure of reception of the multicast packet MC from the communication apparatus 11 and reports it to the communication apparatus 11 by the RDI.

The communication system according to this embodiment has the same configuration as the above-described communication apparatus 11 and, therefore, has the same operation and effects as described above.

### Second Embodiment

In the first embodiment, the communication controllers 39 and 59 perform the stop control of transmission of the multicast packet MC by changing the setting of band values of the band controllers 30 and 50. However, the present disclosure is not limited thereto. The communication controllers 39 and 59 may perform the stop control of transmission of the multicast packet MC, for example, by changing the MAC address tables 360 and 560, as described below.

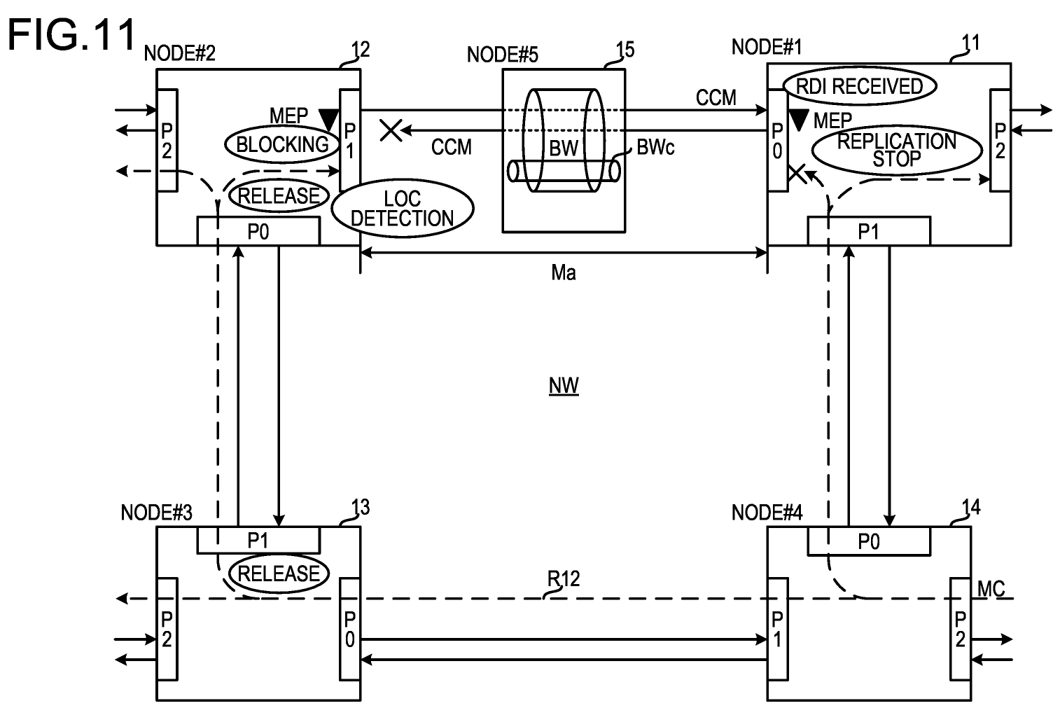

FIG. 11 illustrates the operation of a communication system according to a second embodiment. In FIG. 11, the same elements as those in FIG. 9 will be denoted by the same reference numerals as used in FIG. 9, and explanation thereof will be omitted.

Upon receiving the RDI (see “RDI RECEIVED”), the communication apparatus 11 stops replicating the multicast packet MC input from the port P1 and transmitting it to the port P0 (see “REPLICATION STOP”). Therefore, similar to the first embodiment, in the communication apparatus 15 of the node #5, the band BWc occupied by the discarded multicast packet MC is released. The stop control of transmission of the multicast packet MC is performed by changing the MAC address table 560 of the IF card 21, as described below.

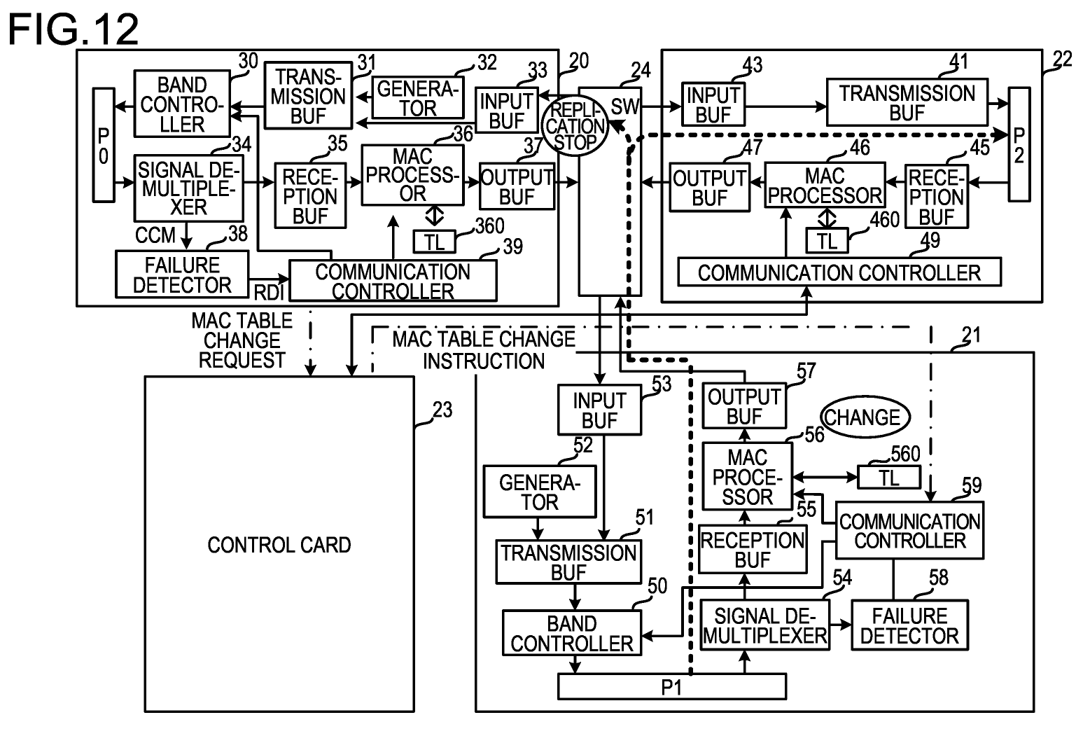

FIG. 12 illustrates the operation of the communication apparatus 11 according to the second embodiment. In FIG. 12, the same elements as those in FIG. 10 will be denoted by the same reference numerals as used in FIG. 10, and explanation thereof will be omitted.

The communication controller 39 of the IF card 20 changes the MAC address table 560 of the IF card 21 according to RDI so as to prevent the multicast packet MC from being transmitted to the band controller 30. More specifically, upon receiving RDI from the failure detector 38, the communication controller 39 requests the control card 23 to change the MAC address table 560 so as to prevent the multicast packet MC from being transmitted from the IF card 21 to the IF card 20.

Upon receiving from the communication controller 39 the request to change the MAC address table 560, the control card 23 instructs the communication controller 59 of the IF card 21 to change the MAC address table 560. The communication controller 59 outputs the instruction to change the MAC address table 560 to the MAC processor 56.

According to this instruction, the MAC processor 56 changes the MAC address table 560 so as to prevent the multicast packet MC from being transmitted from the IF card 21 to the IF card 20 (see “CHANGE”). Accordingly, although the IF card 21 outputs the multicast packet, which is input from the port P1, to the SW card 24, as indicated by a dashed line, the SW card 24 stops replicating the multicast packet MC to be output to the IF card 20 (see “REPLICATION STOP”).

Therefore, the multicast packet MC does not reach the band controller 30 of the IF card 20. For the IF card 22, the SW card 24 replicates and outputs the multicast packet MC.

In this embodiment, unlike the first embodiment, the communication controller 39 may stop the transmission of the multicast packet MC at the SW card 24 immediately before the IF card 20. That is, the communication controller 39 may perform the stop control of transmission of the multicast packet MC before inputting the multicast packet MC to the IF card 20. Therefore, the process of the multicast packet MC by the IF card 20 may be omitted. For example, wasteful use of a resource in the IF card 20, such as the input buffer 33 or the transmission buffer 31, may be omitted.

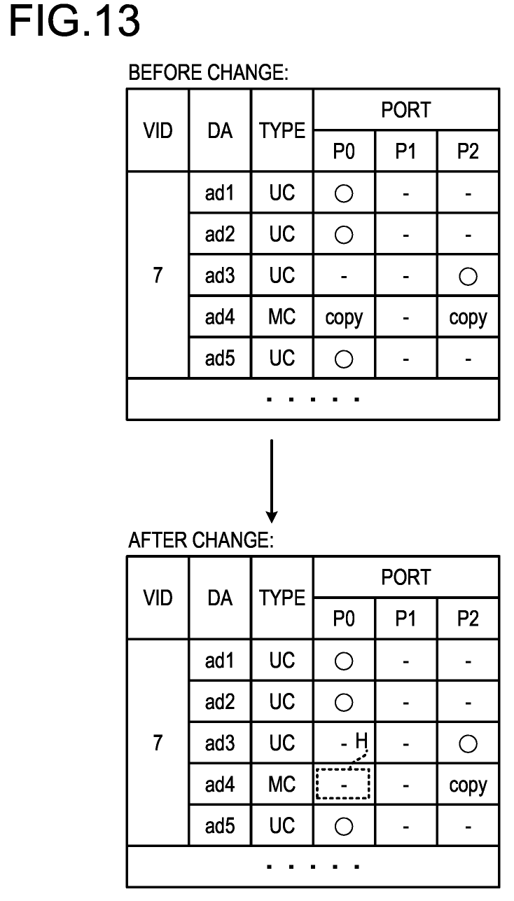

FIG. 13 illustrates the MAC address table 560 before and after being changed. The MAC address table 560 registers VID, DA, a packet type (UC: unicast, and MC: multicast), and ports P0 to P2 of a reception destination. Although FIG. 13 illustrates an example of the MAC address table 560, other MAC address tables 460 and 560 also have the same configuration.

The MAC processor 56 detects the VID of a packet, DA, and ports P0 to P2 of a reception destination according to the type by referring to the MAC address table 560 and adds reception destination information to the packet. For the unicast packet UC (type=UC), the MAC processor 56 adds an identifier of the ports P0 to P2 indicating “◯”, as reception destination information, to the unicast packet UC of the corresponding VID and DA. The SW card 24 outputs the unicast packet UC to the IF cards 20 to 22 of the ports P0 to P2 according to the reception destination information.

For example, the MAC processor 56 adds the reception destination information indicating the port P0 to the unicast packet UC of VID=7 and DA=ad1. This unicast packet UC is input to the SW card 24 and then output to the IF card 20 of the port P0. Accordingly, the MAC processor 56 transmits the unicast packet UC to the IF cards 20 to 22 according to the reception destination.

For the multicast packet MC (type =MC), the MAC processor 56 adds an identifier of the ports P0 to P2 indicating “copy,” as reception destination information, to the multicast packet MC of the corresponding VID and DA. That is, the “copy” indicates the ports P0 to P2 of an output destination of copy of the multicast packet MC. The SW card 24 replicates the multicast packet MC by the ports P0 to P2 according to the reception destination information and outputs the replicated packets to the corresponding IF cards 20 to 22.

For the MAC address table 560 before being changed, for example, the MAC processor 56 adds reception destination information indicating the ports P0 and P2 to the multicast packet MC of VID=7 and DA=ad4. This multicast packet MC is input to the SW card 24 and then replicated and output to the IF cards 20 and 22 of the ports P0 and P2. Accordingly, the MAC processor 56 transmits the multicast packet MC to a plurality of IF cards 20 to 22.

Upon receiving from the communication controller 59 an instruction to change the MAC address table 560, the MAC processor 56 changes the setting of the corresponding multicast packet MC. In this example, the MAC processor 56 changes the setting of the port P0 as an output destination of replication of the multicast packet MC of VID=7 and DA=ad4 from the “copy” to “−,” as indicated by a symbol H. Accordingly, the port P0 is excluded from the reception destination information of this multicast packet MC.

Accordingly, the SW card 24 outputs the replica of the multicast packet MC to only the IF card 22 without outputting the replicated packets to the IF card 20. Accordingly, the communication controller 39 may perform the stop control of transmission of the multicast packet MC before inputting the multicast packet MC to the IF card 20. While the above-described operation is performed for the case of the example of FIG. 11, when a failure occurs between the communication apparatus 11 and the communication apparatus 14, the communication controller 59 and the MAC processor 36 are operated in the same way as the communication controller 59 and the MAC processor 56.

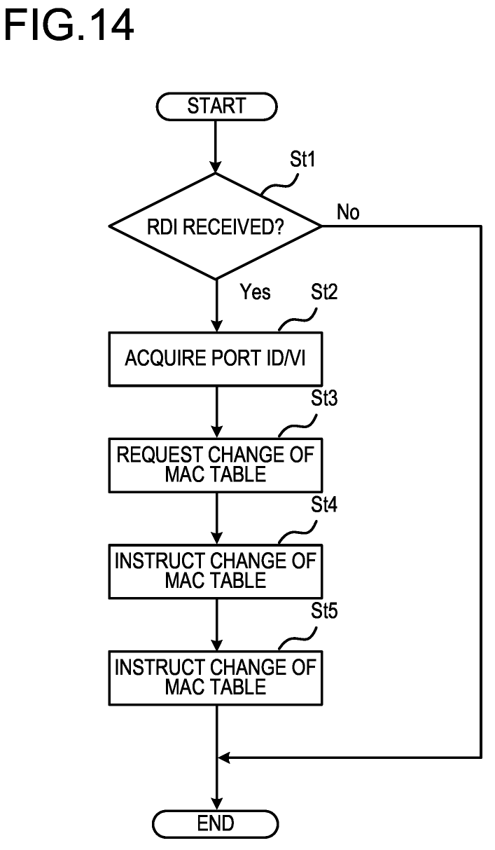

FIG. 14 is a flow chart illustrating the operation of the communication apparatus 11 according to the second embodiment. Although this operation is for the case of the example of FIG. 11, the same operation is performed for other cases.

The failure detector 38 determines whether or not the RDI has been received from the communication apparatus 12 (Operation St1). When it is determined that the RDI has not been received (No in Operation St1), the operation is ended.

When it is determined that the RDI has been received (Yes in Operation St1), the communication controller 39 acquires port IDs (P0 to P2) of the ports P0 to P2 that received the RDI, and VID of the multicast packet MC to be stopped (Operation St2). The VID is acquired from a CCM packet including the RDI, as described above.

Next, the communication controller 39 requests the control card 23 to change the MAC address table 560 (Operation St3). This request includes the acquired port IDs and VID.

Next, based on this request, the control card 23 instructs the communication controller 59 of the IF card 21 to change the MAC address table 560 (Operation St4). This instruction is output from the communication controller 59 to the MAC processor 56.

Next, according to this instruction, the MAC processor 56 changes the MAC address table 560 (Operation St5). The contents of this change are as described above with reference to FIG. 13. The communication apparatus 11 is operated in this manner.

### Third Embodiment

In the second embodiment, the communication controller 39 of the IF card 20 changes the MAC address table 560 of the IF card 21 through the control card 23. However, since time required to change the MAC address table 560 depends on a period of access from the control card 23 to the communication controllers 39, 59 and 49 of the IF cards 20 to 22, the required time may be shortened by using MEP of each of the IF cards 20 to 22 to change the MAC address table 560.

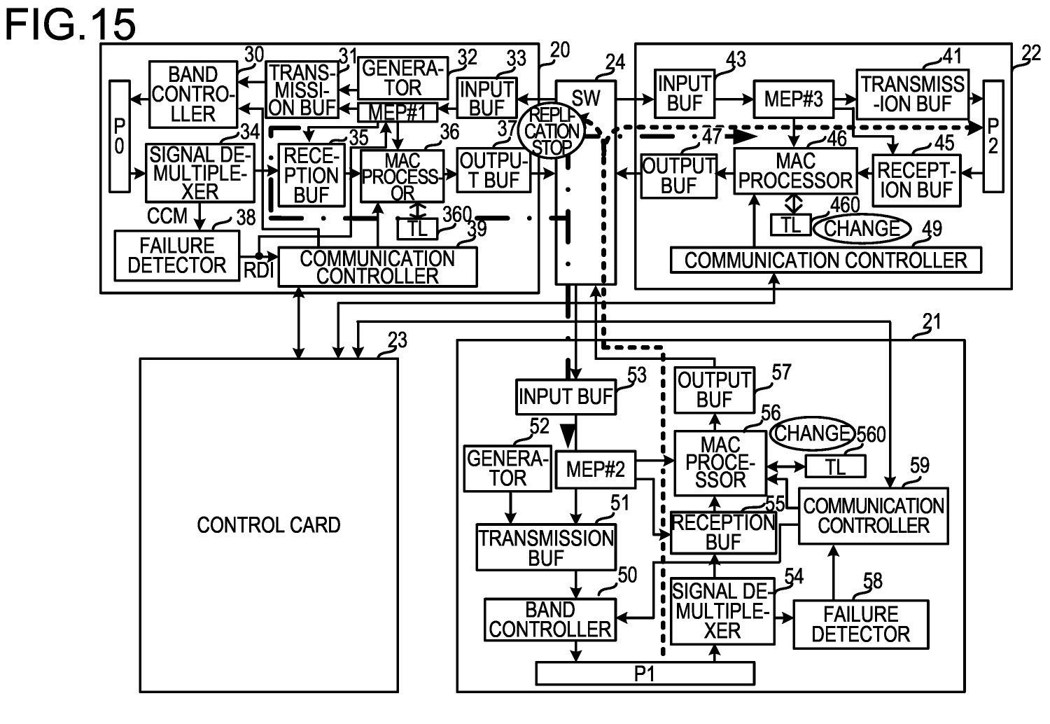

FIG. 15 illustrates the operation of the communication apparatus 11 according to the third embodiment. In FIG. 15, the same elements as those in FIG. 10 will be denoted by the same reference numerals as used in FIG. 10, and explanation thereof will be omitted.

MEPs #1 to #3, which are an example of monitors, are installed in the IF cards 20 to 22, respectively. In the IF card 20, the MEP #1 is installed between the input buffer 33 and the transmission buffer 31. In the IF card 21, the MEP #2 is installed between the input buffer 53 and the transmission buffer 51. In the IF card 22, the MEP #3 is installed between the input buffer 43 and the transmission buffer 41.

The MEPs #1 to #3 monitor the state of a packet transmission route among the IF cards 20 to 22 by periodically transmitting/receiving a CCM packet along the packet transmission route. For example, the MEP #1 receives a CCM packet, which is transmitted from the MEPs #2 and #3, from the input buffer 33 and outputs a CCM packet, which is to be transmitted to the MEPs #2 and #3, to the reception buffer 35. The MEP #2 receives a CCM packet, which is transmitted from the MEPs #1 and #3, from the input buffer 53 and outputs a CCM packet, which is to be transmitted to the MEPs #1 and #3, to the reception buffer 55. The MEP #3 receives a CCM packet, which is transmitted from the MEPs #1 and #2, from the input buffer 43 and outputs a CCM packet, which is to be transmitted to the MEPs #1 and #2, to the reception buffer 45.

The MEP #1 uses the CCM to report the reception of RDI to the MEPs #2 and #3. Upon receiving the report of the reception of the RDI, the MEPs #2 and #3 instruct the MAC processors 46 and 56 to change the MAC address tables 460 and 560, respectively. The contents of this change are as described above with reference to FIG. 13.

In the example of FIG. 11, upon detecting the RDI from the CCM packet received from the communication apparatus 12, the failure detector 38 reports the reception of the RDI, along with VID of the multicast packet MC, to the MEP #1. Upon receiving this report, the MEP #1 adds its own MEP ID(#1), the VID, and the report of RDI RECEIVED to the CCM packet and transmits the CCM packet to the MEPs #2 and #3. The CCM packet transmitted/received by the MEPs #1 to #3 is an example of a monitoring packet.

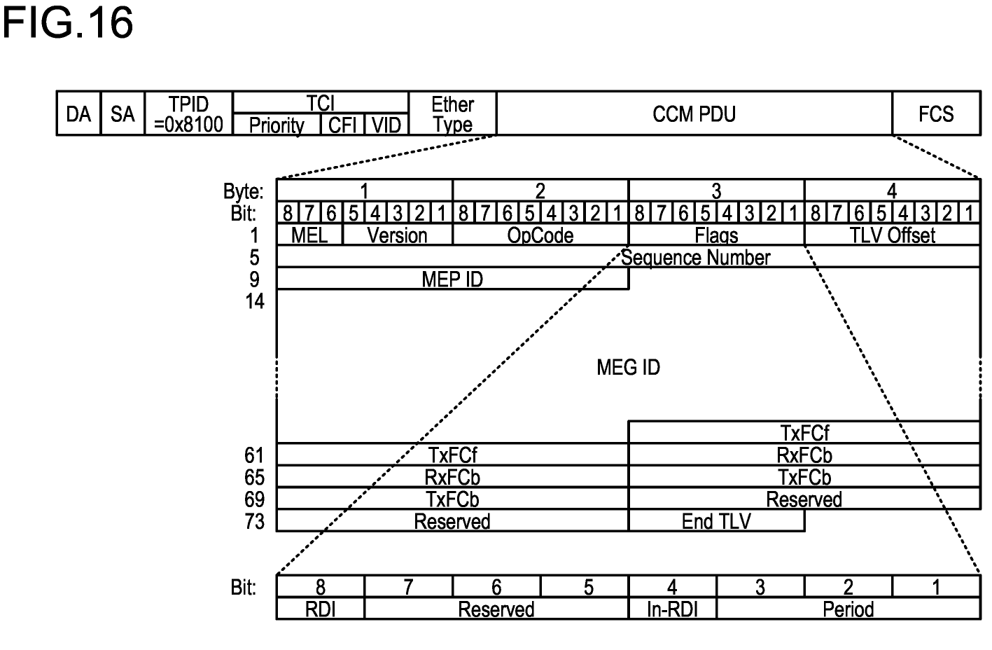

FIG. 16 is a view illustrating a configuration of an exemplary CCM packet. A CCM packet includes DA, SA (Source Address), TPID (Tag Protocol Identifier), TCI (Tag Control Information), Ether Type, CCM PDU, and FCS (Frame Check Sequence). The DA is an MAC address of a reception destination, and the SA is an MAC address of a transmission destination. The TPID is a fixed value of 0x8100 (Ox in hexadecimal notation), and the Ether Type is a protocol type.

The TCI includes Priority, CFI (Canonical Format Indicator) and VID. The Priority indicates a packet priority, and the CFI is a fixed value indicating an Ethernet format. The VID indicates a VID acquired from the CCM packet of the communication apparatus 12. The FCS is a data error correction code.

The CCM PDU includes MEL, Version, OpCode, Flags, TLV Offset, Sequence Number, MEP ID, and MEG ID. The CCM PDU further includes TxFCf, RxFCb, TxFCb, Reserved, and End TLV.

The OpCode is a fixed value of 0x01. The MEP ID is 0x0001 when the CCM packet transmission source is MEP #1.

The Flags includes RDI, Reserved, In-RDI, and Period. The RDI is used to report the occurrence of LOC in the ring network NW. The failure detectors 38 and 58 detect the occurrence of LOC in the communication apparatuses 12 and 14 when RDI=“1.” However, the RDI is not used for the CCM packet among MEPs #1 to #3.

The In-RDI is an example of reception information indicating the reception of RDI. The In-RDI is used to report the reception of RDI from the communication apparatuses 12 and 14. Upon receiving the report of the reception of RDI from the failure detectors 38 and 58, the MEPs #1 to #3 set the In-RDI to “1.” The MEP #1 reports the reception of RDI to the MEPs #2 and #3 by the In-RDI. Other fields in the CCM packet are as defined in the ITU-T Recommendation Y.Y.1731.

Referring back to FIG. 15, the CCM packet is input to the SW card 24 via the reception buffer 35 and the MAC processor 36 and is then input from the SW card 24 to the MEPs #2 and #3 of the IF cards 21 and 22, as indicated by an alternate long and short dashed line. When the report of the reception of RDI is included in the received CCM packet (i.e., In-RDI=“1”), the MEPs #2 and #3 output the MEP ID and VID added to the CCM packet, along with an instruction to change the MAC address tables 460 and 560, to the MAC processors 56 and 46, respectively.

The MAC processor 56, which is an example of a transmission processor, receives the multicast packet MC from the inside of the ring network NW and transmits the packet to the band controller 30 of the IF card 20 according to the MAC address table 560. The MAC processor 46, which is another example of the transmission processor, receives the multicast packet MC from the outside of the ring network NW and transmits the packet to the band controller 30 of the IF card 20 according to the MAC address table 460. The MAC processors 56 and 46 change the MAC address tables 560 and 460 based on the MEP ID and VID according to the instruction from the MEPs #2 and #3, respectively (see “CHANGE”).

Therefore, the multicast packet MC input to the port P1 is input from the IF card 21 to the SW card 24, replicated and then output to the IF card 22, as indicated by a dashed line, but is not output to the IF card 20 (see “REPLICATION STOP”). The multicast packet MC input to the port P2 is also input from the IF card 22 to the SW card 24, replicated and then output to the IF card 21 but is not output to the IF card 20.

In this way, the MEP #1 transmits the CCM packet including the In-RDI indicating the reception of RDI to the MEPs #2 and #3. The MEPs #2 and #3 change the MAC address tables 560 and 460 respectively according to the In-RDI in the CCM packet so as to prevent the multicast packet MC from being transmitted to the band controller 30.

Accordingly, the transmission of the multicast packet MC from the communication apparatus 11 to the communication apparatus 12 is stopped. Therefore, in the communication apparatus 15 of the node #5, the band BWc occupied by the discarded multicast packet MC is released.

In addition, in the same way as the second embodiment, the MEP #1 may perform the stop control of transmission of the multicast packet MC before inputting the multicast packet MC to the IF card 20. Therefore, a process of the multicast packet MC by the IF card 20 may be omitted. For example, wasteful use of a resource in the IF card 20, such as the input buffer 33 or the transmission buffer 31, may be omitted.

In addition, the MEP #1 uses the CCM packet to report the reception of RDI to the MEPs #2 and #3. Since a period of transmission/reception of the CCM packet among the MEPs #1 to #3 is shorter than a period of access from the control card 23 to the IF cards 20 to 22, time required to change the MAC address tables 560 and 460 is shortened.

As described above, the communication apparatus 11 according to this embodiment is installed in the ring network NW and includes the band controller 30, the failure detector 38, the MAC processors 56 and 46, and the MEPs #1 to #3. The band controller 30 transmits the multicast packet MC to other communication apparatus 12 installed in the ring network NW.

The failure detector 38 receives RDI from other communication apparatus 12. The MAC processors 56 and 46 receive the multicast packet MC from the inside of the ring network and transmit the packet to the band controller 30 according to the MAC address tables 560 and 460, respectively. The MEPs #1 to #3 monitor the state of transmission routes of the MAC processors 56 and 46 by transmitting/receiving a monitoring packet along at least some of the transmission routes of the MAC processors 56 and 46.

The MEP #1 transmits the CCM packet including the In-RDI indicating the reception of RDI to the MEPs #2 and #3. The MEPs #2 and #3 change the MAC address tables 560 and 460 respectively according to the In-RDI so as to prevent the multicast packet MC from being transmitted to the band controller 30.

With the above-described configuration, the MEPs #2 and #3 change the MAC address tables 560 and 460 respectively according to the In-RDI so as to prevent the multicast packet MC from being transmitted to the band controller 30. Accordingly, the transmission of the multicast packet MC from the communication apparatus 11 to the communication apparatus 12 is stopped. Therefore, in the communication apparatus 15 of the node #5, the band BWc occupied by the discarded multicast packet MC is released. As a result, the band BWc is prevented from being occupied by traffic discarded when the LOC occurs.

In addition, the communication system according to this embodiment includes the communication apparatus 11 and the communication apparatus 12 installed in the ring network NW. The communication apparatus 11 is installed in the ring network NW and includes the band controller 30, the failure detector 38, the MAC processors 56 and 46, and the MEPs #1 to #3.

The band controller 30 transmits the multicast packet MC to other communication apparatus 12 installed in the ring network NW. The failure detector 38 receives the RDI from other communication apparatus 12. The MAC processors 56 and 46 receive the multicast packet MC from the inside of the ring network and transmit it to the band controller 30 according to the MAC address tables 560 and 460, respectively. The MEPs #1 to #3 monitor the state of transmission routes of the MAC processors 56 and 46 by transmitting/receiving a monitoring packet along at least some of the transmission routes of the MAC processors 56 and 46.

The MEP #1 transmits the CCM packet including the In-RDI indicating the reception of RDI to the MEPs #2 and #3. The MEPs #2 and #3 change the MAC address tables 560 and 460 respectively according to the In-RDI so as to prevent the multicast packet MC from being transmitted to the band controller 30.

The communication system according to this embodiment has the same configuration as the above-described communication apparatus 11 and, therefore, has the same operation and effects as described above.

### Fourth Embodiment

A case where a failure occurs in only a link between the communication apparatus 11 and the communication apparatus 12 has been described in the above embodiments. However, the stop control of the multicast packet MC is also possible for a case where a failure occurs in a link between the communication apparatus 11 and the communication apparatus 12 and a link between the communication apparatus 11 and the communication apparatus 14.

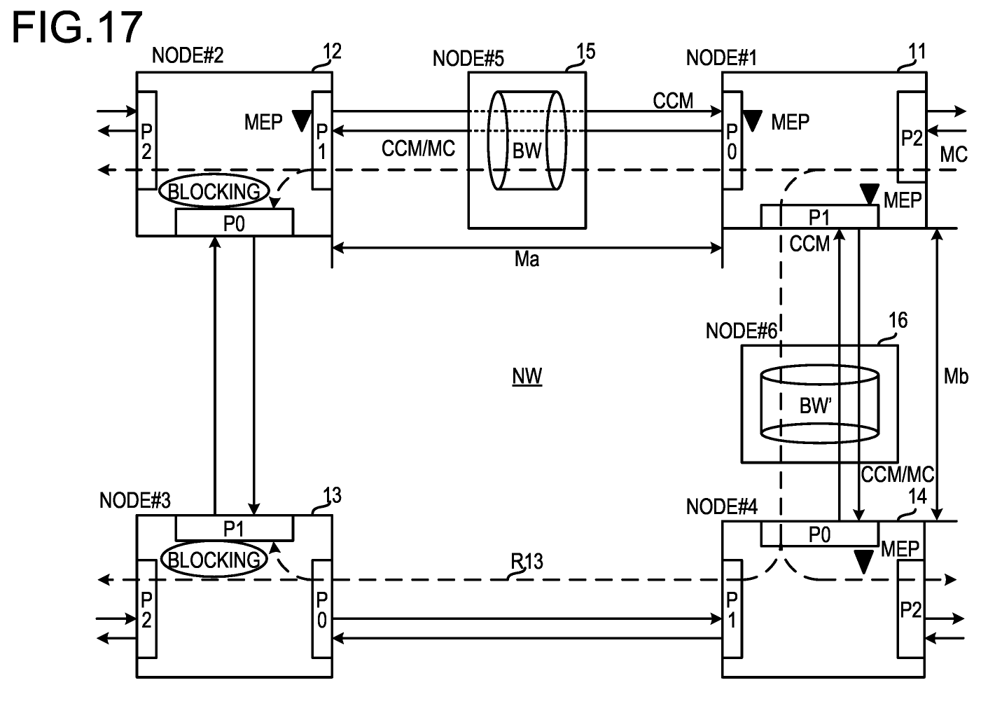

FIG. 17 illustrates a route R13 of a multicast packet MC in a fourth embodiment. In FIG. 17, the same elements as those in FIG. 7 will be denoted by the same reference numerals as used in FIG. 7, and explanation thereof will be omitted.

In addition to the communication apparatuses 11 to 14 of the nodes #1 to #4, a communication apparatus 16 of a node #6 is installed in the ring network NW of this embodiment. The communication apparatus 16 is installed between the communication apparatus 11 and the communication apparatus 14. In this embodiment, the communication apparatus 12 is an example of a first communication apparatus, and the communication apparatus 14 is an example of a second communication apparatus.

In addition, in this embodiment, in addition to a monitoring section Ma between the communication apparatus 11 and the communication apparatus 12, a monitoring route Mb is set between the port P1 of the communication apparatus 11 and the port P0 of the communication apparatus 14, and an MEP is set in the near ends of the port P1 of the communication apparatus 11 and the port P0 of the communication apparatus 14 (see “▾”). A CCM packet is being transmitted/received between the MEPs of the communication apparatuses 11 and 14. Each of the communication apparatuses 11 and 14 monitors the state of a communication route between the communication apparatuses 11 and 14 by transmission/reception of the CCM packet.

In addition, the communication apparatus 16 of the node #6 is installed in a transmission line between the communication apparatuses 11 and 14. Therefore, the CCM packet is transmitted/received via the communication apparatus 16.

As an example, a route R13 of the multicast packet MC is set in the ring network NW. The route R13 is divided in each of the communication apparatuses 11 and 14 of the nodes #1 to #4, as indicated by a dashed line. However, the multicast packet MC cannot pass between the communication apparatus 12 and the communication apparatus 13 due to the blocking of the ports P0 and P1 of the communication apparatuses 12 and 13.

The communication apparatus 11 replicates the multicast packet MC input from the port P2 and transmits it to the ports P0 and P1. The port P0 transmits the multicast packet MC to the communication apparatus 12, and the port P1 transmits the multicast packet MC to the communication apparatus 14. Therefore, a unicast packet UC and a CCM packet are transmitted using a band BW of the communication apparatus 15 and a band BW' of the communication apparatus 16.

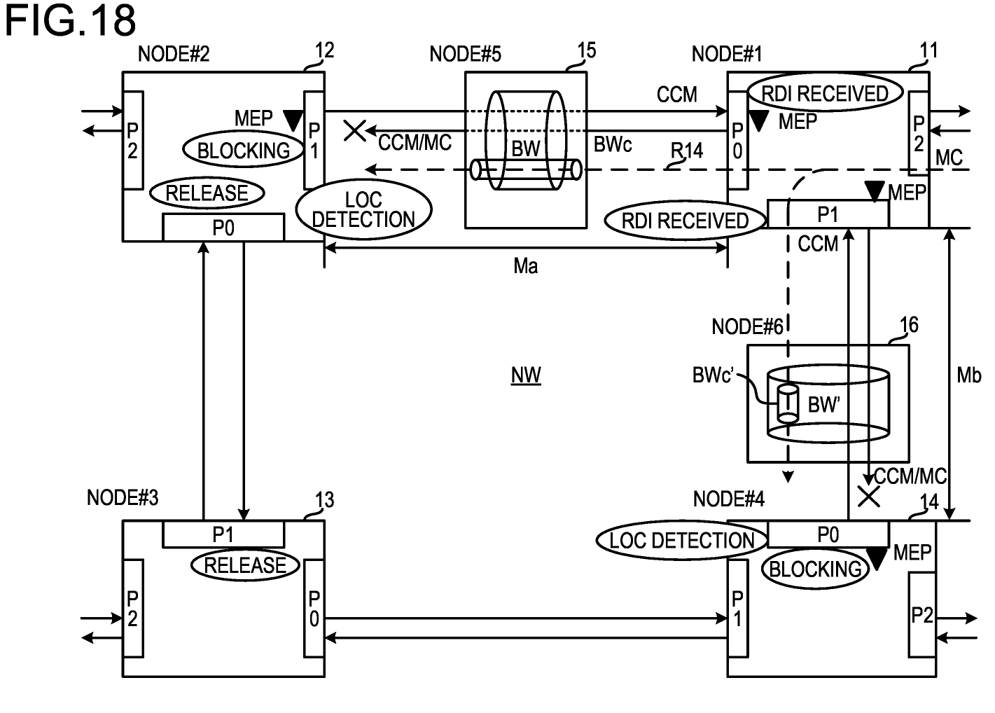

FIG. 18 illustrates a route R14 of a multicast packet MC in the event of a failure in the fourth embodiment. In FIG. 18, the same elements as those in FIG. 17 will be denoted by the same reference numerals as used in FIG. 17, and explanation thereof will be omitted.

In this embodiment, in addition to the communication apparatus 12 of the node #2, the communication apparatus 12 of the node #4 also detects the LOC because a CCM packet is not received (see “LOC DETECTION”). That is, the LOC occurs simultaneously in a link between the communication apparatus 11 and the communication apparatus 12 and a link between the communication apparatus 11 and the communication apparatus 14. Therefore, the communication apparatus 12 and the communication apparatus 14 are unable to receive the CCM packet and the unicast packet UC (see “x”).

At this time, the blocking of the port P0 of the communication apparatus 12 and the port P1 of the communication apparatus 13 is released (see “RELEASE”). In addition, the communication apparatus 12 blocks the port P1 in which the LOC is detected, and the communication apparatus 14 blocks the port P0 in which the LOC is detected (see “BLOCKING”).

The communication apparatus 12 and the communication apparatus 14 report the occurrence of the LOC to the communication apparatus 11 by RDI included in the CCM. At this time, a transmission line directing from the communication apparatus 12 and the communication apparatus 14 to the communication apparatus 11a is assumed normal. The communication apparatus 11 detects the occurrence of the LOC in the communication apparatus 12 and the communication apparatus 14 by receiving the RDI (see “RDI RECEIVED”).

However, since the communication apparatus 11 does not block the ports P0 and P1, the communication apparatus 11 transmits the multicast packet MC to the communication apparatus 12 via the communication apparatus 15 of the node #5 and transmits the multicast packet MC to the communication apparatus 14 via the communication apparatus 16 of the node #6. In this state, a band BWc of the communication apparatus 15 and a band BWc' of the communication apparatus 16 are wastefully occupied by traffic of the discarded multicast packet MC. Therefore, the communication apparatus 11 performs the stop control of transmission of the multicast packet MC from the ports P0 and P1, as described below.

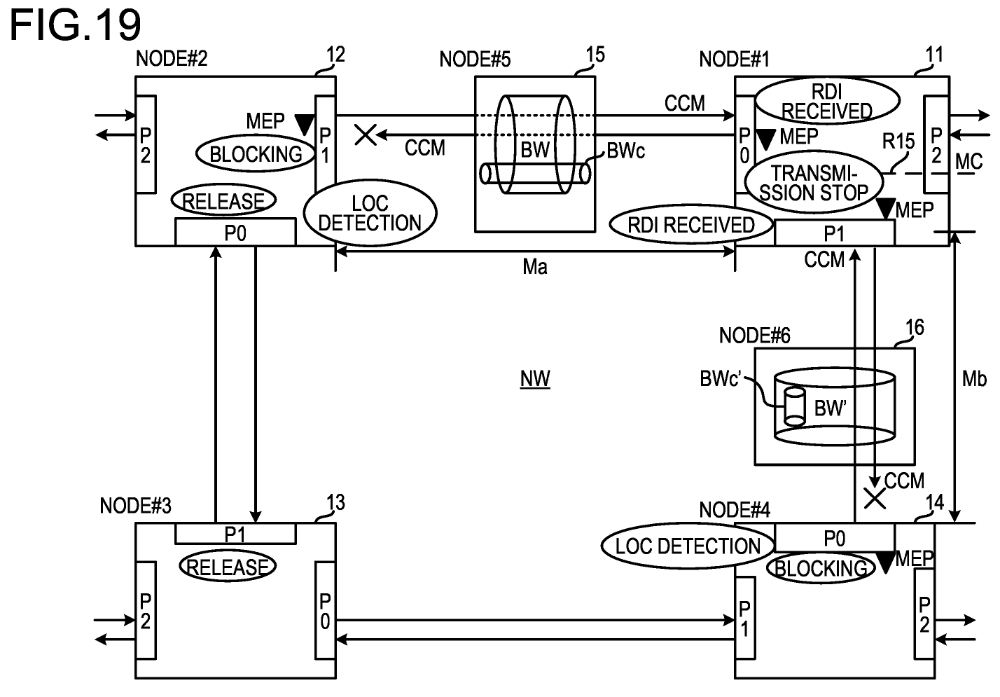

FIG. 19 illustrates the operation of a communication system according to the fourth embodiment. In FIG. 19, the same elements as those in FIG. 17 will be denoted by the same reference numerals as used in FIG. 17, and explanation thereof will be repeated. Reference numeral R15 denotes a route of a multicast packet MC.

Upon receiving the RDI in the port P0 and the port P1, the communication apparatus 11 performs the stop control of transmission of the multicast packet MC from the port P2 to the ports P0 and P1 (see “TRANSMISSION STOP”). Therefore, in the communication apparatus 15 of the node #5, the band BWc occupied by the discarded multicast packet MC is released. In addition, in the communication apparatus 16 of the node #6, the band BWc' occupied by the discarded multicast packet MC is released.

Accordingly, the bands BWc and BWc′ are prevented from being occupied by traffic discarded when the LOC occurs. Accordingly, the communication apparatus 15 and the communication apparatus 16 may use the released bands BWc and BWc′ for other traffic.

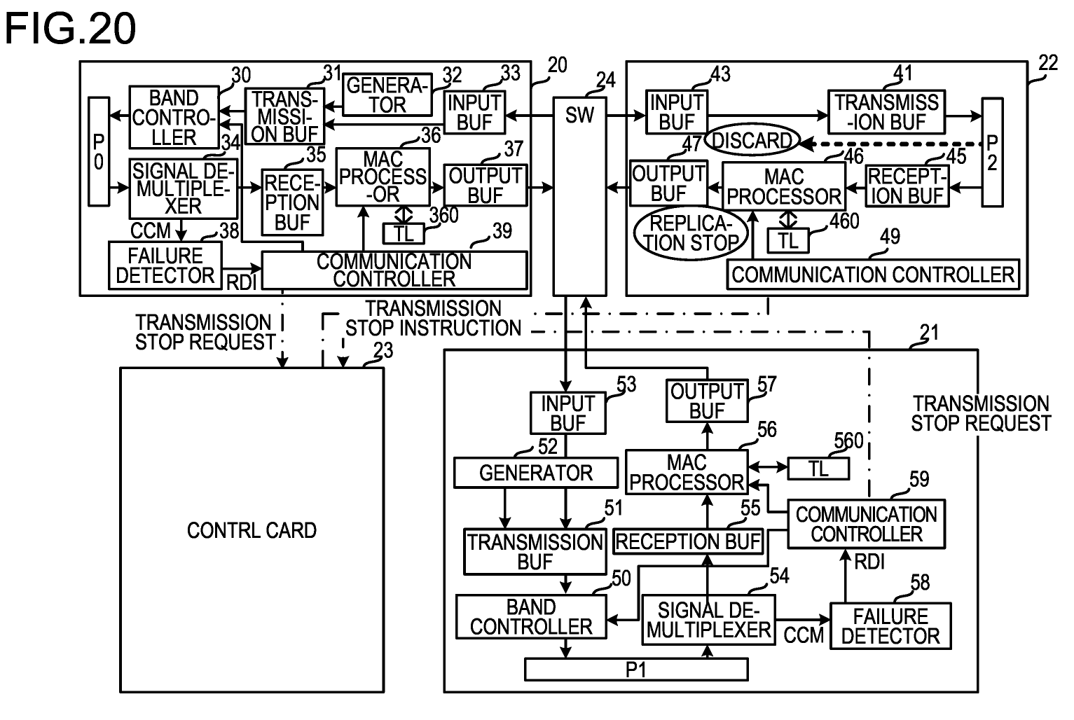

FIG. 20 illustrates the operation of the communication apparatus 11 according to the fourth embodiment. In FIG. 20, the same elements as those in FIG. 10 will be denoted by the same reference numerals as used in FIG. 10, and explanation thereof will be omitted.

In this embodiment, the band controller 30 of the IF card 20 is an example of a first transmitting part for transmitting the multicast packet MC to the communication apparatus 12, and the failure detector 38 is an example of a first receiving part for receiving RDI from the communication apparatus 12. The band controller 50 of the IF card 21 is an example of a second transmitting part for transmitting the multicast packet MC to the communication apparatus 14, and the failure detector 58 is an example of a second receiving part for receiving RDI from the communication apparatus 14.

The multicast packet MC is input from the port P2 and output from the ports P0 and P1, as described above with reference to FIG. 17. Therefore, the IF card 22 outputs the multicast packet MC to the IF card 20 and the IF card 21 via the SW card 24. The MAC processor 46 of the IF card 22, which is an example of a transmission processor, receives the multicast packet MC from the outside of the ring network NW and transmits it to each of the band controllers 30 and 50.

When the LOC is detected in the communication apparatus 12, the failure detector 38 receives the RDI by a CCM packet input from the signal de-multiplexer 34. Upon detecting the occurrence of the LOC by the reception of the RDI, the failure detector 38 reports the RDI, along with a VID of the CCM packet, to the communication controller 39. At this time, the communication controller 39 designates a VID and a port ID (P0) and requests the control card 23 to stop the transmission of the multicast packet MC.

When the LOC is detected in the communication apparatus 14, the failure detector 58 receives the RDI by a CCM packet input from the signal de-multiplexer 54. Upon detecting the occurrence of the LOC by the reception of the RDI, the failure detector 58 reports the RDI, along with a VID of the CCM packet, to the communication controller 59. At this time, the communication controller 59 designates a VID and a port ID (P1) and requests the control card 23 to stop the transmission of the multicast packet MC.

The control card 23 is an example of a transmission controller. When the failure detectors 38 and 58 receive the RDI, the control card 23 performs the stop control of transmission of the multicast packet MC from the MAC processor 46 of the IF card 22 to the band controllers 30 and 50. More specifically, upon receiving from the communication controller 39 of the IF card 20 and the communication controller 59 of the IF card 21 a request to stop the transmission of the multicast packet MC, the control card 23 instructs the communication controller 49 of the IF card 22 to stop the transmission of the multicast packet MC.

According to the instruction to stop the transmission of the multicast packet MC, the communication controller 49 instructs the MAC processor 46 to discard the multicast packet MC corresponding to the designated VID and port IDs (P0 and P1). According to this instruction, the MAC processor 46 stops the transmission (see “TRANSMISSION STOP”) by discarding the multicast packet MC input from the port P2 (see a dashed line and “DISCARD”). At this time, the MAC processor 46 identifies the multicast packet MC corresponding to the designated VID and port IDs (P1 and P2), for example, by referring to the MAC address table 460.

Accordingly, since the multicast packet MC is not input to the IF card 20 and the IF card 21, the multicast packet MC is not transmitted to the communication apparatuses 12 and 14 which detected the LOC. Accordingly, in the communication apparatus 15 of the node #5, the band BWc occupied by the discarded multicast packet MC is released. In addition, in the communication apparatus 16 of the node #6, the band BWc′ occupied by the discarded multicast packet MC is released.

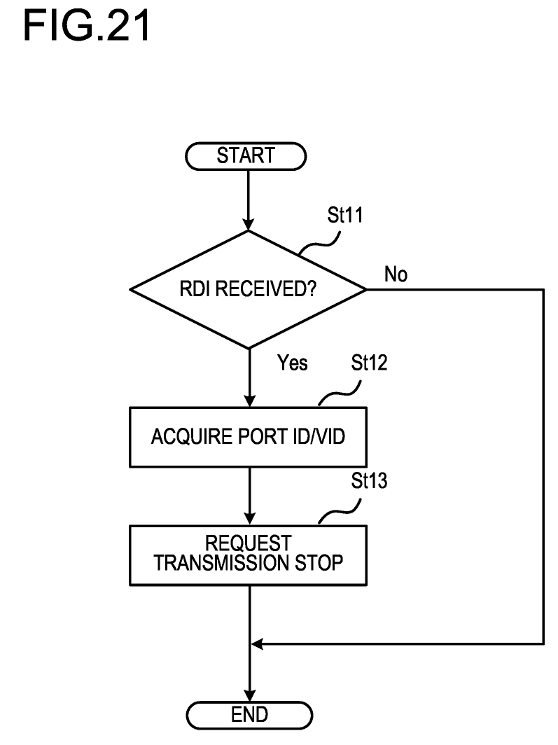

FIG. 21 is a flow chart illustrating the operation of the IF cards 20 and 21 according to the fourth embodiment. The failure detectors 38 and 58 determine whether or not the RDI has been received from the communication apparatuses 12 and 14 (Operation St11). When it is determined that the RDI has not been received (No in Operation St11), the operation is ended.

When it is determined that the RDI has been received (Yes in Operation St11), the communication controllers 39 and 59 acquire port IDs (P0 and P1) of the ports P0 to P2 that received the RDI, and a VID of the multicast packet MC to be stopped (Operation St12). The VID is acquired from a CCM packet including the RDI, as described above.

Next, the communication controllers 39 and 59 request the control card 23 to stop the transmission of the multicast packet MC (Operation St13). The transmission stop request includes the VID and port IDs. The IF cards 20 and 21 are operated in this manner.

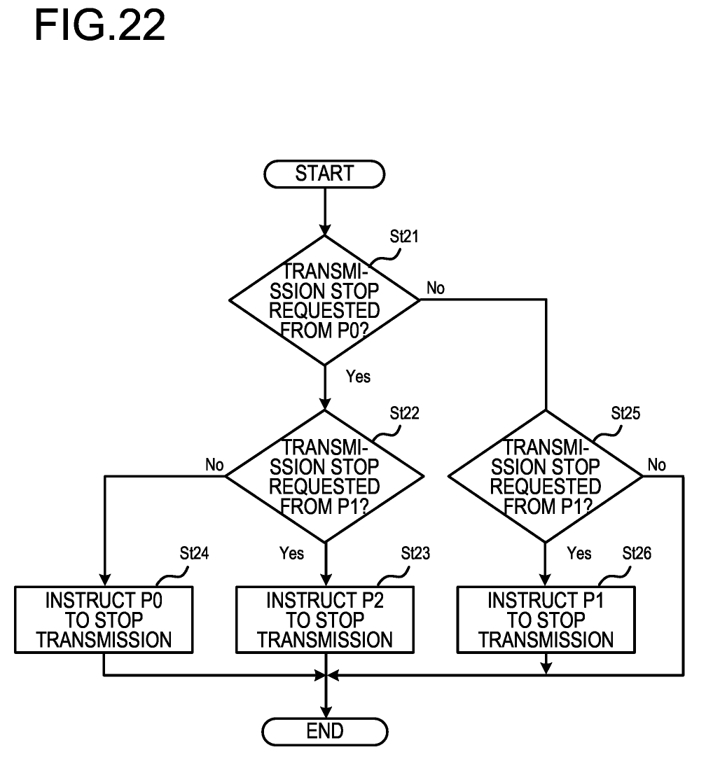

FIG. 22 is a flow chart illustrating the operation of the IF card 23 according to the fourth embodiment. The control card 23 determines whether or not there is a request from the IF card 20 of the port P0 to stop the transmission (Operation St21). When it is determined that there is a request from the IF card 20 of the port P0 to stop the transmission (Yes in Operation St21), the control card 23 determines whether or not there is a request from the IF card 21 of the port P1 to stop the transmission (Operation St22).

When it is determined that there is a request from the IF card 21 of the port P1 to stop the transmission (Yes in Operation St22), the control card 23 instructs the communication controller 49 of the IF card 22 of the port P2 to stop the transmission of the multicast packet MC (Operation St23). That is, upon receiving a request from the IF cards 20 and 21 to stop the transmission, the control card 23 instructs the communication controller 49 of the IF card 22 to stop the transmission of the multicast packet MC.

When it is determined that there is no request from the IF card 21 of the port P1 to stop the transmission (No in Operation St22), the control card 23 instructs the communication controller 59 of the IF card 20 of the port P0 to stop the transmission of the multicast packet MC (Operation St24). That is, upon receiving a request from only the IF card 20 to stop the transmission, the control card 23 instructs the communication controller 39 of the IF card 20 to stop the transmission of the multicast packet MC.

At this time, in the same way as the first embodiment, the communication controller 39 instructs the band controller 30 to set a band value of the multicast packet MC of the corresponding VID to 0. Accordingly, since the multicast packet MC is discarded in the band controller 30, the multicast packet MC is not transmitted from the port P0.

When it is determined that there is no request from the IF card 20 of the port P0 to stop the transmission (No in Operation St21), the control card 23 determines whether or not there is a request from the IF card 21 of the port P1 to stop the transmission (Operation St25). When it is determined that there is no request from the IF card 21 of the port P1 to stop the transmission (No in Operation St25), the operation is ended.

When it is determined that there is a request from the IF card 21 of the port P1 to stop the transmission (Yes in Operation St25), the control card 23 instructs the communication controller 39 of the IF card 21 to stop the transmission of the multicast packet MC (Operation St26). That is, upon receiving a request from only the IF card 21 to stop the transmission, the control card 23 instructs the communication controller 59 of the IF card 21 to stop the transmission of the multicast packet MC.

At this time, in the same way as the first embodiment, the communication controller 59 instructs the band controller 50 to set a band value of the multicast packet MC of the corresponding VID to 0. Accordingly, since the multicast packet MC is discarded in the band controller 50, the multicast packet MC is not transmitted from the port P1. The control card 23 is operated in this manner.

As described above, the communication apparatus 11 according to this embodiment is installed in the ring network NW and includes the band controllers 30 and 50, the failure detectors 38 and 58, the MAC processor 46, and the control card 23.

The band controller 30 transmits the multicast packet MC to the communication apparatus 12 installed in the ring network NW. The failure detector 38 receives the RDI of the multicast packet MC from the communication device 12.

The band controller 50 transmits the multicast packet MC to the communication apparatus 14 installed in the ring network NW. The failure detector 58 receives the report of reception failure of the multicast packet MC from the communication device 14.

The MAC processor 46 receives the multicast packet MC from the outside of the ring network NW and transmits the packet to the band controllers 30 and 50. When the failure detectors 38 and 58 receive the RDI, the control card 23 performs the stop control of transmission of the multicast packet MC from the MAC processor 46 to the band controllers 30 and 50.

With the above-described configuration, since the multicast packet MC is not input to the band controllers 30 and 50, the multicast packet MC is not transmitted to the communication apparatuses 12 and 14 which detected the LOC. Accordingly, in the communication apparatus 15 of the node #5, the band BWc occupied by the discarded multicast packet MC is released. In addition, in the communication apparatus 16 of the node #6, the band BWc′ occupied by the discarded multicast packet MC is released. Accordingly, the bands BWc and BWc′ are prevented from being occupied by traffic discarded when the LOC occurs.

In addition, the communication system according to this embodiment includes the communication apparatuses 11, 12, and 14 installed in the ring network NW. The communication apparatus 11 includes the band controllers 30 and 50, the failure detectors 38 and 58, the MAC processor 46, and the control card 23.

The band controller 30 transmits the multicast packet MC to the communication apparatus 12 installed in the ring network NW. The failure detector 38 receives the RDI of the multicast packet MC from the communication device 12.

The band controller 50 transmits the multicast packet MC to the communication apparatus 14 installed in the ring network NW. The failure detector 58 receives the report of reception failure of the multicast packet MC from the communication device 14.

The MAC processor 46 receives the multicast packet MC from the outside of the ring network NW and transmits the packet to each of the band controllers 30 and 50. When the failure detectors 38 and 58 receive the RDI, the control card 23 performs the stop control of transmission of the multicast packet MC from the MAC processor 46 to the band controllers 30 and 50.

The communication apparatus 12 detects the LOC as a failure of reception of the multicast packet MC from the communication apparatus 11 and reports it to the communication apparatus 11 by the RDI. The communication apparatus 14 detects the LOC as a failure of reception of the multicast packet MC from the communication apparatus 11 and reports it to the communication apparatus 11 by the RDI.

The communication system according to this embodiment has the same configuration as the above-described communication apparatus 11 and, therefore, has the same operation and effects as described above.

The above-described embodiments are examples of preferred embodiments of the present inventions. However, the present invention is not limited thereto but it should be understood that various modifications can be made without departing from the spirit and scope of the invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus of a plurality of communication apparatuses forming a ring network, the communication apparatus comprising:
a transmitter configured to transmit a multicast packet to a first communication apparatus of the plurality of communication apparatuses;
a receiver configured to receive data of a reception failure of the multicast packet from the first communication apparatus; and
a transmission controller configured to stop transmitting of the multicast packet from the transmitter according to the data of the reception failure.

2. The communication apparatus according to claim 1, further comprising:
a transmission processor configured to receive the multicast packet from the inside or outside of the ring network and transfer the multicast packet to the transmitter according to transmission information indicating a transmission destination of the multicast packet,
wherein the transmission controller changes the transmission information according to the data of the reception failure so as to prevent the multicast packet from being transferred to the transmitter.

3. The communication apparatus according to claim 1,
wherein the transmission controller identifies the multicast packet to be stopped transmitting, based on identification information of the multicast packet according to the data of the reception failure.

4. The communication apparatus according to claim 2, further comprising:
a set of monitors configured to receive and transmit monitoring packets on at least a portion of a transmission route on which the transmission processor transfers the multicast packet so as to monitor a state of the transmission route,
wherein one of the set of monitors transmits the monitoring packet including reception information indicating reception of the data of the reception failure to the other of the set of monitors, and
wherein the other of the set of monitors changes the transmission information according to the reception information so as to prevent the multicast packet from being transferred to the transmitter.

5. The communication apparatus according to claim 2,
wherein the transmitter includes a first transmitter configured to transmit the multicast packet to the first communication apparatus and a second transmitter configured to transmit the multicast packet to a second communication apparatus of the plurality of communication apparatuses,
wherein the receiver includes a first receiver configured to receive the data of the reception failure of the multicast packet from the first communication apparatus and a second receiver configured to receive the data of the reception failure of the multicast packet from the second communication apparatus,
wherein the transmission processor configured to transfer the multicast packet received from the outside of the ring network to the first transmitter and the second transmitter, and
wherein the transmission controller controls the transmission processor to stop transmitting of the multicast packet to the first transmitter and the second transmitter when each of the first receiver and the second receiver receives the data of the reception failure.

6. A communication system including a plurality of communication apparatuses forming a ring network, the communication system comprising:
a third communication apparatus of the plurality of communication apparatuses including:
a transmitter configured to transmit a multicast packet; and
a fourth communication apparatus of the plurality of communication apparatuses, which detects a reception failure of the multicast packet transmitted from the third communication apparatus and transmits detected data of the reception failure to the third communication apparatus,
wherein the third communication apparatus further includes:
a receiver configured to receive the data of the reception failure of the multicast packet transmitted from the fourth communication apparatus, and
a transmission controller configure to control the transmitter to stop transmitting of the multicast packet according to the data of the reception failure.

7. The communication system according to claim 6,
wherein the third communication apparatus further includes:
a transmission processor configured to receive the multicast packet from inside or outside of the ring network and transfer the multicast packet to the transmitter according to transmission information indicating a transmission destination of the multicast packet, and
wherein the transmission controller changes the transmission information according to the data of the reception failure so as to prevent the multicast packet from being transmitted to the transmitter.

8. The communication system according to claim 6,
wherein the transmission controller identifies the multicast packet to be stopped transmitting, based on the identification information of the multicast packet according to the data of the reception failure.

9. The communication system according to claim 7,
wherein the third communication apparatus further includes
a set of monitors configured to receive and transmit monitoring packets on at least a portion of a transmission route on which the transmission processor transfers the multicast packet so as to monitor a state of the transmission route,
wherein one of the set of monitors transmits the monitoring packet including reception information indicating reception of the data of the reception failure to the other of set of monitors, and
wherein the other of the set of monitors changes the transmission information according to the reception information so as to prevent the multicast packet from being transferred to the transmitter.

10. A communication system including a plurality of communication apparatuses forming a ring network, the plurality of communication apparatuses including a first communication apparatus, a second communication apparatus, and a third communication apparatus, the communication system comprising:
a first transmitter of the third communication apparatus configured to transmit a multicast packet to the first communication apparatus;
a first receiver of the third communication apparatus configured to receive data of a reception failure of the multicast packet transmitted from the first communication apparatus;
a second transmitter of the third communication apparatus configured to transmit the multicast packet to the second communication apparatus;
a second receiver of the third communication apparatus configured to receive the data of the reception failure of the multicast packet transmitted from the second communication apparatus;
a transmission processor of the third communication apparatus configured to transfer the multicast packet received from the outside of the ring network to the first transmitter and the second transmitter; and
a transmission controller of the third communication apparatus configured to control the transmission processor to stop transmitting of the multicast packet to the first transmitter and the second transmitter when each of the first receiver and the second receiver receives the data of the reception failure,
wherein the first communication apparatus detects the reception failure of the multicast packet transmitted from the third communication apparatus and transmits the detected reception failure of the multicast packet to the third communication apparatus, and
wherein the second communication apparatus detects the reception failure of the multicast packet transmitted from the third communication apparatus and transmits the detected reception failure of the multicast packet to the third communication apparatus.
